(19) United States
(12) Patent Application Publication
(10) Pub. No.: US 2024/0095308 A1
(43) Pub. Date: Mar. 21, 2024

(54) USING AN ADAPTIVE THRESHOLD FOR ANOMALY DETECTION

(71) Applicant: DataShapes, Inc., Kentfield, CA (US)

(72) Inventors: Tyson J. Thomas, Kentfield, CA (US); Gray L. Selby, Kentfield, CA (US); Kristopher R. Buschelman, Kentfield, CA (US)

(21) Appl. No.: 18/328,185

(22) Filed: Jun. 2, 2023

Related U.S. Application Data
(60) Provisional application No. 63/375,902, filed on Sep. 16, 2022.

(51) Int. Cl. G06F 18/21; G06F 18/2415

(52) U.S. Cl. CPC G06F 18/217; G06F 18/2415

(57) ABSTRACT

Disclosed are some implementations of methods, apparatuses, systems, and computer program products including non-transitory computer-readable storage media directed to anomaly detection. In some implementations, input vectors can be obtained in association with a learning process. The input vectors can be iteratively processed to compute a knowledge map. The input vectors can be iteratively processed to determine metadata associated with one or more knowledge elements. An anomaly value can be determined based on the knowledge map and the metadata. An alert can be raised indicating that an anomaly was detected if the anomaly value traverses a threshold.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### TECHNICAL FIELD

The present disclosure relates to pattern identification and pattern recognition, and more particularly to detection of anomalies in observed patterns.

### BACKGROUND

Pattern recognition involves classification of data (patterns) based on either a priori knowledge or on statistical information extracted from the patterns. The patterns to be classified are usually groups of measurements or observations (vectors), defining points in a multidimensional space. A pattern recognition system may include a sensor that gathers the observations to be classified or described; a feature extraction mechanism that computes numeric or symbolic information from the observations; and a classification or description scheme that performs the actual function of classifying or describing observations, relying on the extracted features.

The classification or description scheme is usually based on the availability of a set of patterns that have already been classified or described. This set of patterns is termed the training set and the resulting learning strategy is characterized as supervised learning. Learning can also be unsupervised, in the sense that the system is not given an a priori labeling of patterns, instead it establishes the classes itself based on the statistical regularities of the patterns. A hybrid learning approach can be utilized where the system is given both an a priori labeling of patterns as well as unlabeled data.

A wide range of algorithms can be applied for pattern recognition and anomaly detection, from very simple Bayesian classifiers to neural networks. An artificial neural network (ANN), often just called a “neural network” (NN), is an interconnected group of artificial neurons that uses a mathematical model or computational model for information processing based on a connectionist approach to computation. An ANN can be an adaptive system that changes its structure based on external or internal information that flows through the network. Artificial neural networks can be used to model complex relationships between inputs and outputs or to find patterns in data. For many years, academia and industry have been researching pattern recognition based on artificial neural networks. However, this research has yielded methods and algorithms that required substantial computation power as well as substantial memory.

Typical applications for pattern recognition are automatic speech recognition, classification of text into several categories (e.g. spam/non-spam email messages), the automatic recognition of handwritten postal codes on postal envelopes, or the automatic recognition of images of human faces. The last two examples form the subtopic image analysis of pattern recognition that deals with digital images as input to pattern recognition systems.

Anomaly detection generally refers to the identification of events or observations that differ from normal behavior. Anomalous events or observations are rare by definition. Typical applications for anomaly detection include event detection with sensors, fault detection, system health monitoring, automatic fault detection, detection of network intrusion, etc.

### SUMMARY

In some implementations, methods, apparatuses, systems, and computer program products including non-transitory computer-readable storage media can be directed to anomaly detection. In some implementations, input vectors can be obtained in association with a learning process. The input vectors can be iteratively processed to compute a knowledge map. The input vectors can be iteratively processed to determine metadata associated with one or more knowledge elements. An anomaly value can be determined based on the knowledge map and the metadata. An alert can be raised indicating that an anomaly was detected if the anomaly value traverses a threshold.

Some examples include detecting at least one of a discrete anomaly outlier or a drift anomaly outlier. Some examples include identifying an anomaly event based on a statistical measure of a number of the input vectors within a designated timeframe.

Some examples include applying the threshold to one or more of: a number of input vectors determined to be abnormal, or a speed by which a statistical measure of the number of abnormal vectors changes within a designated timeframe.

In some examples, the learning process includes one or more of: a continuous learning process or a periodic learning process

In some examples, the knowledge map includes one or more of: a quality of the one or more knowledge elements, a model miss rate, a number of the one or more knowledge elements, a model hit count, or an age of the one or more knowledge elements.

In some implementations, an anomaly detection engine can be co-located with a sensor system and can be configured to communicate with a data processing system. The anomaly detection engine can be configured to: determine an anomaly of an input vector, classify, based on the anomaly of the input vector, measured data associated with the sensor system, and cause a message to be sent from an edge device to the data processing system based on the classification.

In some examples, the anomaly detection engine can be configured to cause the message to be sent from the edge device to the data processing system when a level of the anomaly of the input vector traverses a threshold.

In some examples, the anomaly detection engine can be further configured to cause messages to not be sent from the edge device to the data processing system when a level of the anomaly of the input vector does not traverse a threshold.

In some implementations, a data processing system can be configured to communicate with an anomaly detection engine co-located with a sensor system. The data processing system can be configured to: determine that an event designated by an edge device as an anomaly is not an anomaly and send a message to the edge device. The message can indicate that the event should not be designated as the anomaly. The message can be configured to cause the anomaly detection engine to create, in association with the edge device, a knowledge element indicating that the event is not an anomaly.

In some examples, the message can be configured to prevent the anomaly detection engine from designating a future event as an anomaly based on a similarity between or among input vectors.

In some examples, the message can be configured to prevent the anomaly detection engine from reporting detection of an anomaly to the data processing system based on a similarity between or among input vectors.

A further understanding of the nature and advantages of various implementations may be realized by reference to the remaining portions of the specification and the drawings.

### BRIEF DESCRIPTION OF THE DRAWINGS

FIG. 1 is a schematic diagram illustrating an example system according to some implementations.

FIG. 2 is a schematic diagram illustrating the plug-in stack component of an example inspection server.

FIG. 3 is a schematic diagram illustrating a software and hardware stack architecture according to some implementations.

FIG. 4 is a schematic illustrating an example system architecture according to some implementations.

FIG. 5 is a schematic diagram illustrating an example computing system architecture according to some implementations.

FIG. 6 is a flow diagram illustrating multiple feature extraction processes applied to an input.

FIG. 7 graphically illustrates a knowledge map for didactic purposes.

FIG. 8 graphically illustrates matching of input vectors to knowledge elements according to some implementations.

FIG. 9 is a flow chart showing a method directed to matching knowledge elements against input vectors.

FIGS. 10 thru 16 are charts that graphically illustrate a learning function according to some implementations.

FIG. 17 is a flow chart showing a method directed to a learning function according to some implementations.

FIG. 18 is a flow chart showing a method directed to a half-learning function according to some implementations.

FIGS. 19 and 20 are schematic diagrams illustrating interaction of pattern recognition system components.

FIG. 21 is a schematic diagram showing an example programmable logic circuit according to some implementations.

FIG. 22 is a schematic diagram showing an example programmable logic circuit according to some implementations.

FIGS. 23 to 26 illustrate how an example implementation may process input vectors in a pipelining mechanism.

FIGS. 27a-c show a flow chart illustrating an example method according to some implementations.

FIGS. 28a-b illustrate examples of a relationship between knowledge element weight value and an average distance between a knowledge element and the input vectors that are within the influence distance of a vector.

FIGS. 29a-d illustrate example histograms of anomaly values related to a threshold probability distribution function and associated parameters.

FIG. 30 illustrates an example of a knowledge element.

FIG. 31 illustrates an example time series of anomaly histograms values.

FIG. 32 illustrates an example sequence of histograms of anomaly values at different times.

FIG. 33 illustrates an example block diagram of an environment wherein anomaly detection may be performed.

FIG. 34 illustrates an example block diagram and various interconnections of an environment wherein anomaly detection may be performed.

### DETAILED DESCRIPTION

Some implementations of methods, apparatuses, systems, and computer program products including non-transitory computer-readable storage media are directed to identification of anomalies in a pattern of observations. Some implementations provide a flexible anomaly recognition platform including anomaly detection engines that can dynamically adjust operations based on the operating environment and the observed patterns.

In some implementations, a flexible pattern recognition platform includes pattern recognition engines that can be dynamically adjusted to implement specific pattern recognition configurations for individual pattern recognition applications. In some implementations, the pattern recognition engines also or alternatively can be self-adjusted based on one or more changes in an operating environment. Some implementations provide a partition configuration where knowledge elements can be grouped and pattern recognition operations can be individually configured and arranged to allow for edge, cloud or hybrid computing architecture for anomaly detection. In some implementations, concurrent or near concurrent anomaly detection provide real-time pattern identification and recognition via an edge, cloud or hybrid computing architecture. In some implementations, the system is also data-agnostic and can handle any type of data (image, video, audio, chemical, text, binary, etc.). Still further, some implementations provide systems capable of providing proximity (fuzzy) recognition or exact matching, via a recognition engine which is autonomous once it has been taught.

### A. Overview of Pattern Recognition

Generally, pattern recognition involves generation of input vectors potentially through feature extraction, and comparison of the input vectors to a set of known vectors that are associated with categories or identifiers. One finds example logic for pattern identification and pattern recognition in the following five patents, whose disclosures are hereby incorporated by reference: U.S. Pat. Nos. 5,621,863; 5,701,397; 5,710,869; 5,717,832; and 5,740,326.

A vector, in one implementation, is an array or 1-dimensional matrix of operands, where each operand holds a value. Comparison of an input vector to a known vector generally involves applying a distance calculation algorithm to compute the individual distances between corresponding operands of the input vector and the known vector, and in accordance to the distance calculation algorithm in use to combine in some fashion the individual distances to yield an aggregate distance between the input vector and the known vector(s). How the aggregate distances are used in recognition operations depends on the comparison technique or methodology used to compare input vectors to known vectors. There are a variety of ways to compare vectors and to compute aggregate distance. In some implementations, the resulting aggregate distance may be compared to a threshold distance (such as in the case of Radial Basis Functions). In other implementations, the aggregate distance can be used to rank the respective matches between the input vector and the known vectors (such as in the case of K Nearest Neighbors (KNN)). Selection of vector layout, comparison techniques and/or distance computation algorithms may affect the performance of a pattern recognition system relative to a variety of requirements including exact or proximity matching, overall accuracy and system throughput.

Using pattern identification and recognition, it is possible to recognize unknowns into categories. A system can learn that multiple similar objects (as expressed by one or more vectors) are of a given category and can recognize when other objects are similar to these known objects. In some implementations, input vectors having known categories can be provided to a pattern recognition system to essentially train the system. In some implementations, a knowledge element is (at a minimum) a combination of a vector and an associated category. As discussed in more detail below, a knowledge element may include other attributes, such as arbitrary user data and influence field values. The knowledge elements may be stored in a memory space or knowledge element array, which as discussed below may be partitioned in a configurable manner. A knowledge map is a set of knowledge elements. In some implementations, a knowledge element, in addition to defining a vector and a category, may further be instantiated as a physical processing element (implemented, for example, in a logic processing unit of a Field Programmable Gate Array (FPGA) that encapsulates processing logic that returns a match result in response to an input data vector.

Data vectors form the basis for the knowledge elements stored in the knowledge map as their operands are the coordinates for the center of the element in n-dimensional space. These data vectors can be derived from analog data sources (such as sensors) or can be based on existing digital data (computer database fields, network packets, etc.). In the case of all analog data sources and some digital data sources, one or more feature extraction processes or techniques can be used in order to provide a data vector compatible with the knowledge map used by the pattern recognition system.

Pattern recognition systems can determine the category of an unknown object when it is exactly the same or “close” to objects they already know about. With a Radial Basis Functions (RBF)-based or similar technique, for example, it is possible for a machine to recognize exact patterns compared with the existing knowledge or similar (close) patterns given the objects defined by knowledge elements in the knowledge map. Further, the systems can expand their knowledge by adding a new instance of a knowledge element in a category (as defined by one or more input vectors), if it is sufficiently different from existing knowledge elements in that category.

For didactic purposes, pattern recognition using Radial Basis Functions (RBFs) is described. As disclosed in the patents identified above, there exists a class of algorithms termed Radial Basis Functions (RBFs). RBFs have many potential uses, one of which is their use in relation to Artificial Neural Networks (ANNs), which can simulate the human brain's pattern identification abilities. RBFs accomplish their task by mapping (learning/training) a “knowledge instance” (knowledge vector) to the coordinates of an n-dimensional object in a coordinate space. Each n-dimensional object has a tunable radius—“influence distance” (initially set to a maximum [or minimum allowed value)—which then defines a shape in n-dimensional space. The influence distance spread across all n-dimensions defines an influence field. In the case of a spherical object, the influence field would define a hypersphere with the vector defining the object mapped to the center. The combination of a vector, the influence distance and a category makes up the core attributes of a knowledge element.

Multiple knowledge elements of the same or differing categories can be “learned” or mapped into the n-dimensional space. These combined knowledge elements define an n-dimensional knowledge map. Multiple knowledge elements may overlap in the n-dimensional space but, in some implementations, are not allowed to overlap if they are of different categories. If such an overlap were to occur at the time of training, the influence distance of the affected existing knowledge elements and the new knowledge element would be reduced just until they no longer overlapped. This reduction will cause the overall influence fields of the knowledge elements in question to be reduced. The reduction in influence distance can continue until the distance reaches a minimum allowed value. At this point, the knowledge element is termed degenerated. Also, at this point, overlaps in influence fields of knowledge elements can occur.

For pattern recognition, an unknown input vector computed in the same fashion as the vectors of the previously stored knowledge elements is compared against the n-dimensional shapes in the knowledge map. If the unknown data vector is within the influence fields of one or more knowledge elements, it is termed “recognized” or “identified.” Otherwise it is not identified. If the unknown vector is within the influence field of knowledge elements within a single category, it is termed “exact identification”. If it falls within the influence fields of knowledge elements in different categories, it is termed “indeterminate identification”.

As discussed above, to process object influence fields and to determine which one of the three result types (exact recognition, not recognized, indeterminate recognition) occurred in recognition operations, a distance can be calculated to facilitate the required comparisons. The data vector format should be compatible and linked with the distance calculation method in use, as is indicated by the formulas shown below. In practice it is computationally more expensive to use hyperspheres (Euclidian distances) to map the knowledge elements, as the corresponding distance calculations require more time-consuming operations. In these cases, the knowledge element can be approximated by replacing a hypersphere with a hypercube, in order to simplify the distance calculations.

The classic approach focuses on two methods, L₁ and Lₛᵤₚ to approximate the hypersphere with a value easier to compute (a hypercube). L₁ is defined as

$${\sum }_{i = 0}^{n} \vert DEVi - TVi \vert , ,$$

and Lₛᵤₚ is defined as |DEVi−TVi|max, where DEVi is the value of vector element i of the knowledge element's vector and TVi is the value of vector element i of the input vector. L₁ emphasizes the TOTAL change of all vector element-value differences between the object's knowledge vector and the input vector. Lₛᵤₚ emphasizes the MAXIMUM change of all vector element-value differences between the knowledge element vector and the test vector. However, as described further below, the pattern recognition system allows the use of other distance calculation algorithms, such as Euclidian geometry (true hypersphere) in addition to the L₁ and Lₛᵤₚ methods.

A pattern recognition engine can be built to implement a RBF or other comparison technique to define knowledge maps, as described above, and different recognition system configurations. Besides comparison technique, key determinates of such an engine are the number of knowledge elements available, width of the data vector supported by the objects, the width and type of the vector operands, the distance calculation methods supported and the number of possible categories the machine can support. Moreover, a computerized machine can be built to define knowledge maps using Bayesian functions, linear functions, etc. as the comparison techniques. The pattern recognition system described here can be implemented using any such functions. That is, the RBF implementations described here are only representative.

### B. Partition-Based Pattern Recognition System

Some implementations provide a highly-configurable pattern recognition system where a set of pattern recognition system attributes (such as vector attributes, comparison techniques, and distance calculation algorithms) can be configured as a so-called partition and selected as needed by a pattern recognition application. In some implementations, the memory space that stores knowledge elements can be partitioned, and a variety of pattern recognition system attributes can be dynamically defined for one or more of the partitions. In one implementation, a pattern recognition engine, such as hardware or a separate software module, maintains the knowledge maps and partitions, while a pattern recognition application accesses the knowledge maps by passing commands to the partition, such as configure, learn and recognize commands. In one implementation, the pattern recognition engine provides a set of application programming interfaces (APIs) that allow applications to define and configure partitions, as well as invoke corresponding partitions for learn and recognize commands.

A partition may include one or more of the following configuration parameters: 1) number of vector operands; 2) vector operand type; 3) vector operand width; 4) comparison technique; 5) distance calculation technique; and 6) maximum number of knowledge elements. A partition may also include additional parameter attributes that depend on one of the foregoing attributes. For example, if RBF is selected as the comparison technique, the initial influence field can be a capped maximum value (MAX Influence—the largest hyperspheres or hyper cubes) or a smaller value which is the distance to the nearest neighbor of the same category or another category. These influence fields can be reduced as additional knowledge is “learned” which is not in the same category, but within the current influence field of an existing knowledge element. In addition, since a partition identifies a comparison type, one or more learning operations may also be affected. For example, if KNN is selected for the comparison type, learned vectors may be simply stored in the knowledge map without checking to determine whether a new knowledge element vector overlaps an influence field of an existing vector, as influence fields are not part of the KNN algorithm.

As discussed above, a pattern recognition engine maintains a knowledge element array which is a memory space for one or more knowledge maps. Each knowledge map includes one or more knowledge elements, which itself includes a vector, and a category identifier. The system allows for partitioning of the number of available knowledge elements to enable concurrent sharing of the pattern recognition resources. This supports multiple users of the knowledge map functionality, or supports a knowledge map application that wants to use it in different ways (e.g., different feature extraction techniques, different initial maximum influence value, different minimum influence value, different distance calculation method). For example, in a vision application one partition might be used for gradient analysis, whereas another partition of the knowledge element array might be used for histogram analysis. The results returned from each partition might be combined in several application-specific ways to achieve a final-recognition result.

A pattern recognition application can invoke a particular partition by identifying the partition when passing a learn, configure, or recognize command to the knowledge element array. The pattern recognition functionality may return results including an identified category, as well as other data configured or associated with the category or a matching knowledge element(s). In one implementation, the pattern recognition engine can be configured to remember the partition identifier of the last command passed to it and apply the last-identified partition to subsequent commands until a new partition is identified.

An overall pattern recognition process may be defined or configured as a series or set of individual pattern recognition operations, each associated with a configured partition. In one implementation, the pattern recognition application can include decisional logic that effectively arranges the partitions in a serial or hierarchical relationship, where each partition can be included in a decisional node including other logic or operations that is traversed during a pattern recognition operation. Traversing the partitions can be done by a host processor, or can be offloaded to a co-processor, or even programmed into a programmable logic circuit, such as an FPGA.

### B.1. Partitions—Data Vectors and Operands

In the prior art, the width of the knowledge vector was fixed. This causes two problems. First, in situations where the input knowledge is smaller than this fixed width, resources are wasted as the full width of the neuron array is not used for each neuron. In some cases this can be dramatic (e.g., a 5-byte input vector being stored in a 64-byte vector width which is fixed). Second, in other situations, the input knowledge might have a natural width wider than the fixed vector width. This could cause loss of fidelity as the data must be scaled down to fit into the vectors. In the pattern recognition system described herein, the width of the knowledge vector of the knowledge elements and test vectors is not fixed. Multiple vector widths (such as 1-, 2-, 4-, 32-, 64-, 128-, 256-byte words) are available to suit the knowledge provided by the application or feature extraction processes. With smaller vector widths, more knowledge elements are available using the same memory resources.

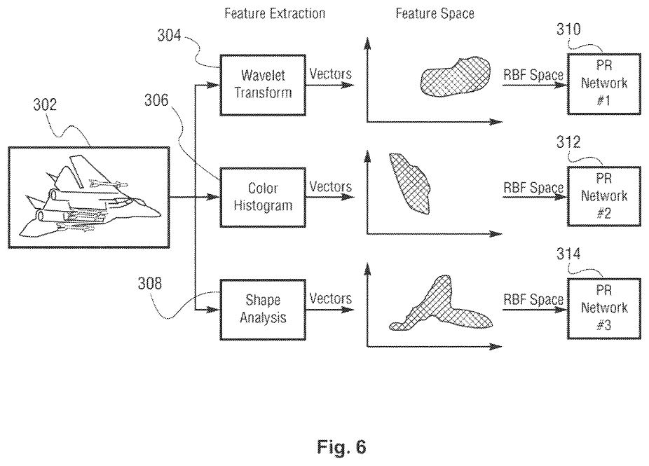

Still further, the pattern recognition system can be used with a variety of supported data types. Knowledge elements and test vectors can be represented with a data vector having operands or vector elements of a variety of widths (as described above) and data types (such as unsigned bytes, signed bytes, unsigned N-bit integers, signed N-bit integers, floating point values, and the like). A given data vector can be generated from already digitized information or information that being fed directly from a sensor. The sensor-based information may be first processed by a feature extraction process (as well as other processes), as shown in FIG. 6. FIG. 6 illustrates a plurality of feature extraction processes 304, 306 and 308 can process a given input data set 302, such as in image captured by an image sensor, to yield corresponding n-dimensional vectors positioned in their respective feature spaces. For example, a color histogram feature extraction process 306 may yield an n-dimensional vector, where n is defined by the number of color bins of the color histogram and the value of each operand is the number of pixels that fall into each respective color bin. Other feature extraction processes may yield or require vectors having a different number of operands, and operand types (such as different widths and data types). As FIG. 6 illustrates, each of the resulting data vectors can be applied to a corresponding pattern recognition network 310, 312 and 314, each contained within a partition and each including a knowledge map for training/learning and/or pattern recognition operations. In one implementation, a partition may be configured for each feature extraction process, where the number and type attributes of the vector elements are defined based on the requirements or properties of each feature extraction process. For example, the wavelet transform process 304 may require that a data vector having 15 elements or operands, each having an 8-bit width are configured. The color histogram process 306 may require a data vector with 30 operands or elements, each having a 32-bit width.

### B.2. Partitions—Comparison and Distance Calculation Techniques

As discussed above, a partition may be configured that identifies a comparison technique used to compare an input (test) data vector and a known vector of a knowledge element. Selectable comparison techniques include Radial Basis Functions, K Nearest Neighbor functions, Bayesian functions, as well as many others described in scientific literature Additionally, after a comparison technique is selected, one or more technique specific parameters may be configured (such as maximum and minimum influence fields for RBF comparisons). Further an interface is defined so that users of the pattern recognition system can build their own pluggable comparison technique modules, if those provided by the pattern recognition system are not sufficient. Additionally, if one or more applications with different needs are using the knowledge element array, one could set up each partition to use different pluggable comparison technique modules.

Still further, the algorithm for computing the distance between an input vector and a known vector can also be configured. For example, one from a variety of algorithms can be selected, such as Euclidian distance, L1, Lsup, linear distance and the like. As discussed above, however, L1 and Lsup are approximations of the true hyper-spatial distance which would be calculated using Euclidian geometry. In the pattern recognition system according to various implementations, the math for doing distance calculation is “pluggable.” This means that a given application can determine which math modules are available and request the one appropriate for its needs in terms of natural distance calculation, e.g., a module that uses Euclidian geometry and floating point numbers. Further an interface is defined so that users of the pattern recognition system can build their own pluggable distance calculation modules, if those provided by the pattern recognition system are not sufficient. In this manner, a user can set the width of the individual components of their input vectors, treat them as the appropriate data type (integer, floating point, or other) and can apply any distance-calculation algorithm that they desire or that the pattern recognition system chooses to provide. Additionally, if one or more applications with different needs are using the knowledge element array, one could set up each partition to use different pluggable distance calculation modules.

### B.3. Partitions—Weighting & Masking

In the prior art, there was no way to mask off portions of the existing knowledge of a vector or to weight different parts of the trained knowledge element vector as might be needed on subsequent recognition operations. For example, a set of knowledge elements might be trained on an entire image, but in some subsequent recognition operations only the center of the images might need to be taken into consideration. In the pattern recognition system according to one implementation, mask vectors and/or weighting vectors can be used when matching against an existing knowledge base. In one implementation, masking and weighting of operand vectors is part of a recognition operation. In one implementation, an application may cause the pattern recognition engine to mask a vector operand by identifying a partition and the operand(s) to be masked in a mask command. An application may cause the pattern recognition engine to weight vectors operands by issuing a weight command that identifies a partition, the operands to be weighted, and the weighting values to be used. In one implementation the active influence field of a knowledge element may be temporarily increased or decreased to account for masking vectors or weighting vectors that may be currently in use.

### B.4. Partitions—Higher Level Recognition Operations

Partitions can be configured and arranged in a hierarchy or other structured relationship (series, parallel, branching, etc.) to provide for solutions to complex pattern recognition operations. A pattern recognition application, for example, may define an overall pattern recognition operation as a set of individual pattern recognition operations and include decisional logic that creates a structured relationship between the individual pattern recognition operations. In such an implementation, the results returned by a first set of partitions can be used as inputs to a second, higher level partition. For didactic purposes, the decisional logic can be considered as a set of decisional nodes and a set of rules and processing operations that define relationships between decisional nodes.

A decisional node, in some implementations, may comprise configured logic, such as computer readable instructions, that includes 1) operations applied to one or more inputs prior to calling a pattern recognition engine; 2) calls to one or more partition-based recognition operations implemented by a pattern recognition engine, and/or 3) operations applied to the results returned by the pattern recognition engine. The decisional node may make calls to one or more partitions maintained by the pattern recognition engine. The additional logic of a decisional node can range from simple Boolean operations to more complex operations, such as statistical analysis and time series analysis. Furthermore, the operations responding to the results of pattern recognition operations can select one or more additional decisional nodes for processing.

In some implementations, a decisional node can be implemented as a decisional node object, which is an instantiation of a decisional node class in an object-oriented programming environment. In such an implementation, the class can encapsulate one or more partition operations (as corresponding API calls to the pattern recognition engine). The decisional nodes can be sub-classed to develop a wide array of decisional nodes. As discussed above, additional logic can be developed to establish relationships between decisional nodes as well, and can be configured to interact with other decisional nodes or user level applications to achieve complex, high order processing that involves pattern recognition. For example, in one implementation, a decisional node could be implemented as a finite state machine whose output could change as inputs are provided to it and the results of recognition operations are returned. The resulting state of the finite state machine, at any given time, can be an input to a higher level decisional node, which itself may encapsulate one or more partition operations as well as additional processing logic.

Processing operations associated with a decisional node or a configured set of decisional nodes can be implemented in a variety of manners. Partition operations can be performed by a pattern recognition engine (implemented as a separate thread or process of a general purpose computer, offloaded to a co-processor, and/or implemented in a programmable logic circuit), while the decisional nodes can be implemented as a series of programming instructions associated with a user level application. In other implementations, processing of the decisional nodes can also be offloaded to a co-processor, and/or implemented in a programmable logic circuit.

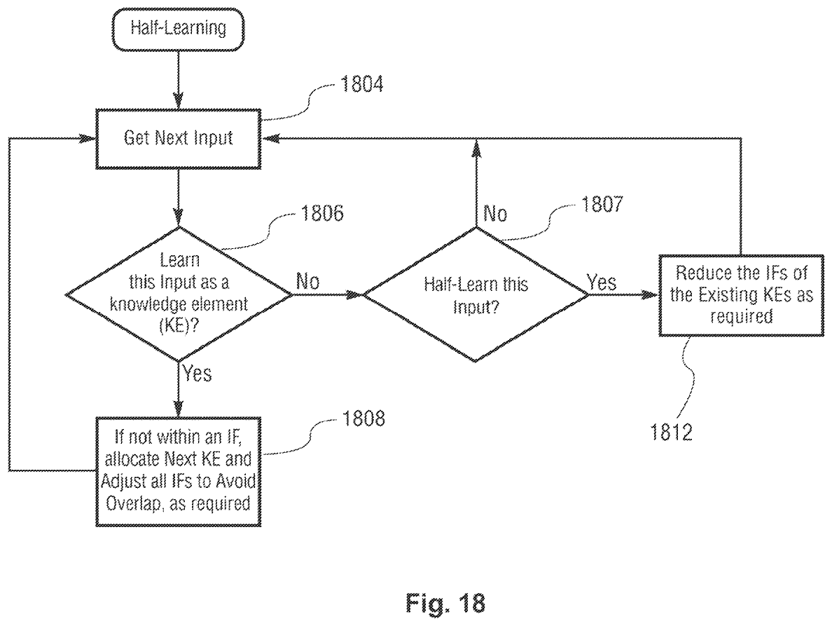

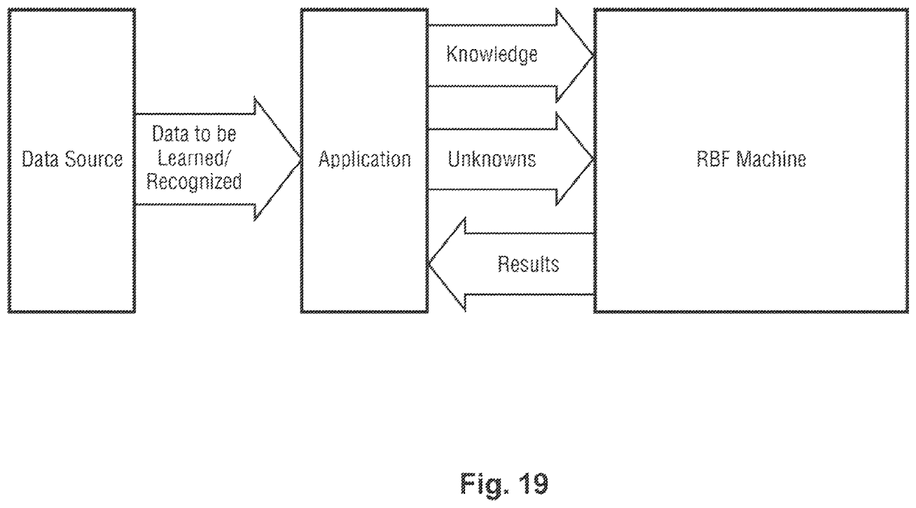

In the prior art, either a single recognition machine is used to identify a certain category of object or multiple recognition machines are used to identify an object when a majority vote wins. For example if two out of three recognition machines returned the same result, the object would be identified as that result. Further, in the existing prior art and scientific literature, RBF machines are used in a flat arrangement, as shown in FIG. 19. However there are large numbers of pattern identification problems where a flat arrangement cannot provide the desired results. These are normally situations where there is a large amount of detail (background and foreground) of different data types that must be processed in order to determine a final pattern recognition result. For example, one might apply a certain technique to input data and, if a match is found, then one might feed different data (based on the first match) calculated by a different technique into another recognition operation to determine a “higher level” recognition result

Using the foregoing, a pattern recognition application can be configured to support a set of pattern recognition operations arranged in a hierarchy or other structured relationship that can be traversed to achieve a final recognition result. For example, a hierarchical configuration of pattern recognition operations can be configured where each decisional node of the hierarchy (pattern recognition partition(s) along with optional control/temporal logic) can identify a subsequent path to take. The results associated with one operational node of the hierarchy can be used to decide the next operational node to be executed and/or can be an input to a subsequent operational node. For example, the results of a first set of partition operations can become through combinational techniques, the input vector to a second, higher level partition or node operation.

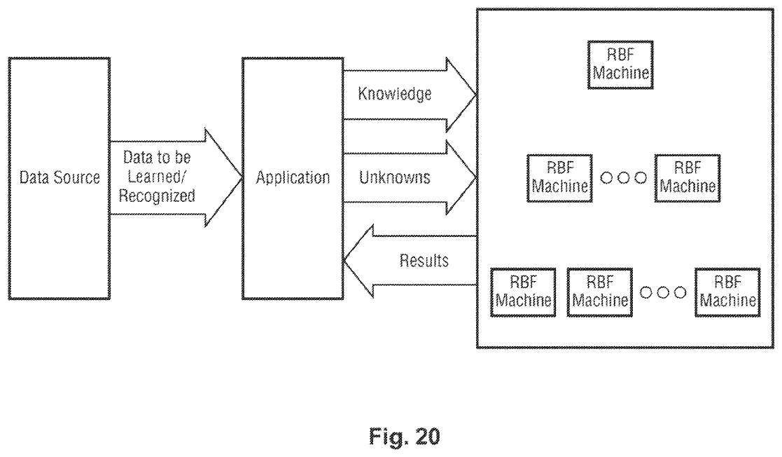

FIG. 20 illustrates a hierarchical recognition system, according to some implementations. A hierarchical recognition system, in one implementation, leverages the pattern recognition system's capabilities described here, including its capabilities with respect to opaque user data (as described in detail below), its partitioning capabilities, and/or its masking capabilities. When a knowledge map is taught a vector/category combination, the knowledge map allows opaque user data to be stored with knowledge elements as they are trained. The knowledge element/map does not process this information. It simply stores it and returns it to the application/user when the knowledge element is matched in a subsequent recognition operation. This opaque user data can be used for lookups (e.g., a key) or other user-defined purpose. This capability could be used to answer the question of why a certain vector fell into a specific category as the opaque data value returned could be used to look up the original training vector (and its source, e.g., picture, sounds, etc.) to present to a user or for use in an auditing application.

The opaque user data of multiple recognition operations could be used as an input vector (via combinatorial logic) to a higher level partition/node, or could also be used to lookup a data vector that could be used as an input vector (via combinatorial logic) to a higher level partition/node. In other implementations, the opaque user data could be used to look up a partition or decisional node to be processed next in a multiple layer pattern recognition application. For example, one recognition stage could use a first partition to provide a result. Via the use of opaque user-data, a subsequent recognition stage, using the same or a different input vector, could be performed in a different partition based on the opaque user data returned by the first recognition stage. This can continue for several levels. Additionally, once a higher level recognition result is achieved, it could be used to weight or mask additional recognition operations at lower levels in the hierarchy, such as to bias them toward the current top-level recognition.

Thus, a pattern recognition application may use multiple partitions or nodes to create the layers or it may create multiple independent layers and connect them as needed. The application decides which partitions/nodes are to be in which layers. To use such a pattern recognition system, the application trains specific knowledge elements with corresponding opaque user data (see above and below) into specific partitions. In the more simplistic case, a given unknown pattern may be presented to the appropriate partitions and the recognition result of each partition (combination of category recognized and/or opaque user data and/or derived data from the opaque user data), if any, would be fed to higher layers in the hierarchy. This process would repeat until a final recognition result was derived at the top of the hierarchy.

An example of this would be the lowest level of the hierarchy recognizing edges of a shape or sub-samples of a sound. Further up in the hierarchy, lines with intersecting angles would be recognized from image data along with tones from sound data. Still further up in the hierarchy, a four legged mammal would be recognized from the image data and the sound “woof” would be recognized from the sound data. Finally at the top of the hierarchy “dog” could be the final recognition result.

Or consider the following example. An image sensor might be pointed at a scene which includes a wall upon which a TV is mounted. First level pattern recognition might detect the corners and edges of the TV in the middle of their field of view. Once the individual elements were recognized, data associated with this recognition operation (e.g., the opaque user data in the pattern recognition system) might contain data on the position of the recognition in the overall scene (e.g., corner located at 2, 4, 8 and 10 o'clock). Similar results might be obtained for the edges. A higher level of recognition might conclude that these patterns in their respective positions formed a box. Recognition techniques using other different approaches might plot color changes. When these results are combined with all other techniques a final result of TV might be the determination at the top of the hierarchy. Once the TV is recognized, masking or weighting might be applied to lower levels in the hierarchy to focus only on the TV and ignore other objects in the scene being recognized, such as paintings on the wall, flying insects, books on a bookshelf, etc. A practical application of this example would be airport security where once a wanted person was identified by the facial patterns, tone of speech, type of clothing, fingerprint, etc., a computerized system could then “follow” this person throughout the facility continuously recognizing the person while somewhat ignoring the surrounding scene. In addition to the spatial examples defined above, additional levels in the hierarchy could use temporal (times series) pattern recognition operations to define their outputs. The input to these levels would be spatial recognitions that are then trended over time to produce a temporal recognition result.

A permutation on this case is that instead of just using one partition's or node's results to feed to a higher level partition or node, multiple lower level partitions could be combined into recognition units (or nodes). In this fashion probabilistic results can be feed further into the hierarchy. An example would be the lower level results are that there is an 80% probability, as opposed to a binary result in the simpler hierarchy.

Through experimentation, the correct numbers of levels are determined along with what to train/recognize in each level and what to feed up to higher levels. A starting point can be to use different knowledge vector feature extraction techniques at the lowest level and map these different techniques to different partitions/nodes. Next one would feed unknown knowledge vectors to the trained lower level to determine what was recognized. Based on these recognition results, the connection to the next level in the hierarchy would be created along with determining suitable feature extraction algorithms and associated logic for that level. In some cases the original training data would be used with different nth-order feature-extraction algorithms to train higher levels, or the output from the lower level (opaque user data or derived from opaque user data) would be used to train the higher level or a combination of the two. Each recognition problem domain may require experimentation to determine what the proper number of levels is, what the levels should be trained with and how they should be connected.

In the previous example, high fidelity recognition results can be obtained by feeding up through a recognition hierarchy. For time series (or temporal) recognition problems, it is also useful to feed a result from higher levels back to lower levels to bias them for the object being recognized and tracked. As an example, once a dog is recognized as barking, it can be advantageous to focus on the barking dog as opposed to blades of grass blowing in the background. The opaque user data could also be used to bias one or multiple levels of the recognition hierarchy once “sub recognitions” occurred at lower levels in the hierarchy to allow them to help focus the “desired” result.

In order to accomplish this, as each level recognizes a specific pattern, it could provide a bias to its own inputs or feed a bias to a lower level in the hierarchy to bias its inputs. This feedback would be accomplished the same way as the feed forward approach, namely, use (1) the recognition results' opaque user data or (2) what that data points to, to provide a bias to the same or a lower level. This would be accomplished by using the masking or weighting functionality described earlier.

### C. Enhancements to Logic for Pattern Identification and Pattern Recognition

As described in the paragraphs below, the system enhances pattern recognition functionality in a variety of manners, in one implementation, making the logic more useful to real-world applications.

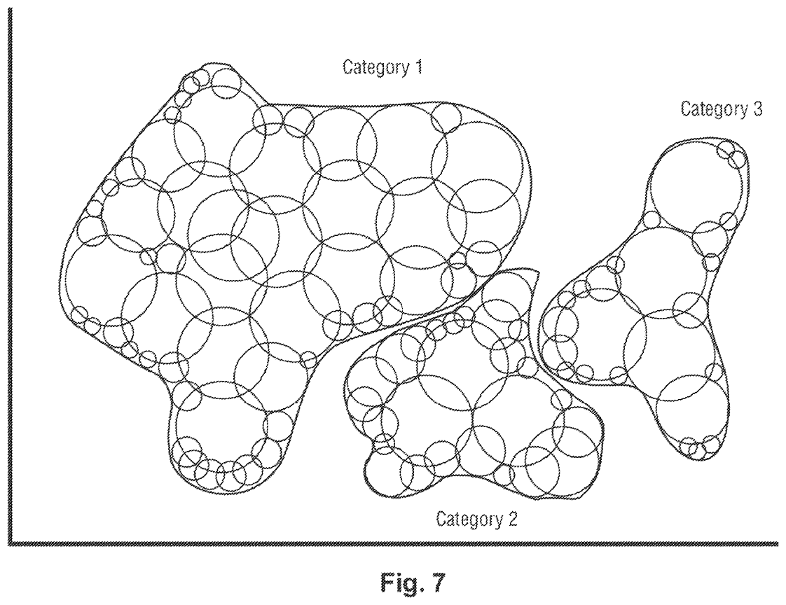

FIG. 7 shows an idealized, example pattern recognition knowledge map that might be defined for a two-dimensional (2D) vector type after array training has progressed to a near final state. Three categories have been defined. There is also an “other” category which is implied in the figure. Pattern recognition approximates the “real” knowledge category map (outer black lines) with a plurality of knowledge elements represented as circles in the idealized diagram of FIG. 7). With sufficient training, the difference between the real map and the approximate map can be quite small. In the case of RBF, knowledge elements are allocated to define a point in N-dimensional space, hold an influence field value (radius) and also remember their category (among other attributes). A collection of these knowledge elements in association with a partition is a knowledge map. As a data vector is taught to the knowledge element array (teaching=data vector+category+optional user data+learn command), it is mapped to the appropriate n-dimensional coordinate. If not within the influence of an existing knowledge element, a knowledge element is allocated for the data vector and then an initial influence field is applied along with the given category and optional user data. When this happens the current influence field of other knowledge element may be reduced so no overlap occurs where the categories would be different. In other words, the influence fields of knowledge elements on the boundary of a category in the knowledge map are reduced so as to not overlap with those in a different category. There is an influence field value (MIN Influence) past which the current influence field cannot be reduced. If this happens, the knowledge element is termed “degenerated.” Teaching data vectors which are not in a category (i.e., they are in the “other” category) is almost exactly the same (e.g., influence fields of existing knowledge elements may be adjusted), but no new knowledge element is allocated. As explained below, this process is called half-learning.

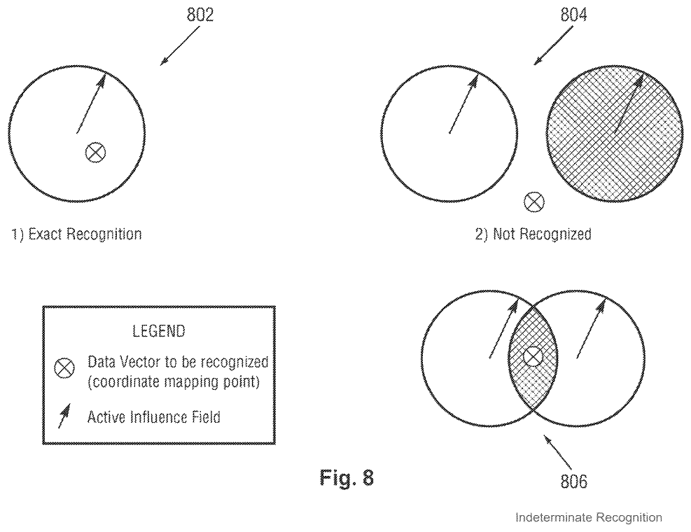

In the recognition phase, input (test) data vectors are presented to the knowledge map and, in one implementation, with a partition identifier. FIG. 8 below shows an example of these three recognition result types. The recognition result can be one of three types:

1. Exact Recognition (802)—The input vector fell within the influence field of knowledge elements of only a single category. The category of these knowledge elements is available to determine the type of information recognized.
2. Not Recognized (804)—The test vector fell outside the influence field of all knowledge elements. This could be a valid result (when an “others” category is appropriate for the knowledge map), or an indication that additional training using the test vector in question is warranted.
3. Indeterminate Recognition (806)—the test vector fell within the current influence fields of more than one knowledge element and those knowledge elements were of different categories. In this case, the category the smallest distance away can be used, the majority category value of the knowledge elements matched can be used, or as with the Not Recognized state, additional training may be warranted.

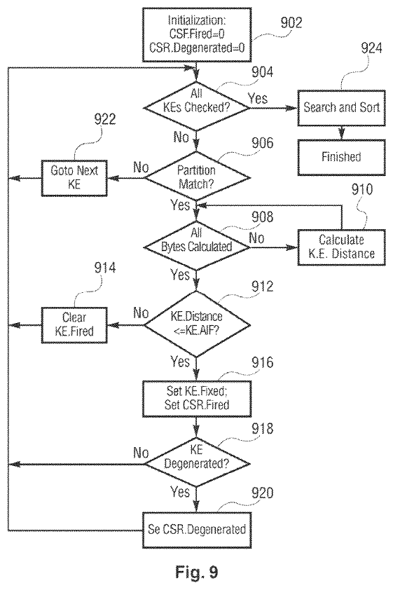

FIG. 9 shows an example flowchart of the logic depicted pictorially in FIG. 8. For example, an application may pass a recognize command to a pattern recognition engine identifying an input data vector and a partition. The pattern recognition engine may initialize one or more operational variables (902) and begin processing the input data vector. For example, the pattern processes the input data vector against all knowledge elements (KEs) (904, 922) that correspond to the identified partition (906). As to a given knowledge element, the pattern recognition engine may compute a distance between a first operand of the input vector and the corresponding operand of the knowledge element vector using the distance calculation algorithm of the identified partition, and repeats this process for all operands to compute an aggregate distance (KE.distance) (908, 910). Next, the pattern recognition system determines whether the aggregate distance between the input vector and the knowledge element vector is within the influence field of the knowledge element (912). If not, the pattern recognition system clears the KE.Fired flag that would otherwise indicate a match (914). If so, the pattern recognition engine sets the KE.Fired flag to indicate a knowledge element and category match (916). Additionally, if the knowledge element is a degenerated element (918), the pattern recognition engine sets a degenerated flag (920). In the implementation shown, after or as knowledge element comparison logic is executed, control logic searches the results and sorts the matching knowledge elements by the respective aggregate distances between the input vector and the knowledge element vectors (924). Other implementations are also possible. For example, if KNN is used, the comparison of influence field to aggregate distance would be omitted. In such an implementation, the top K matching knowledge elements are returned ordered by distance. Still further, if a test vector is matched because it falls within the active influence field of an existing knowledge element, this is a “fuzzy” or “proximity” match. To be an exact match, the test vector would have to be the same (exactly) as the knowledge vector of a knowledge element in the knowledge map. In one implementation, the pattern recognition system allows an application to select proximity (tunable) or exact matching.

### C.1. Optimization of Knowledge Vector Fields

In the prior art, an input vector presented for learning would be rejected if it falls within the influence field of an existing knowledge element in the same category. Yet a subsequent learning operation might allocate a knowledge element in another category which could cause the influence field of the original “matched” knowledge element to be reduced such that if the initial input vector was then presented, it would cause a new knowledge element to be allocated.

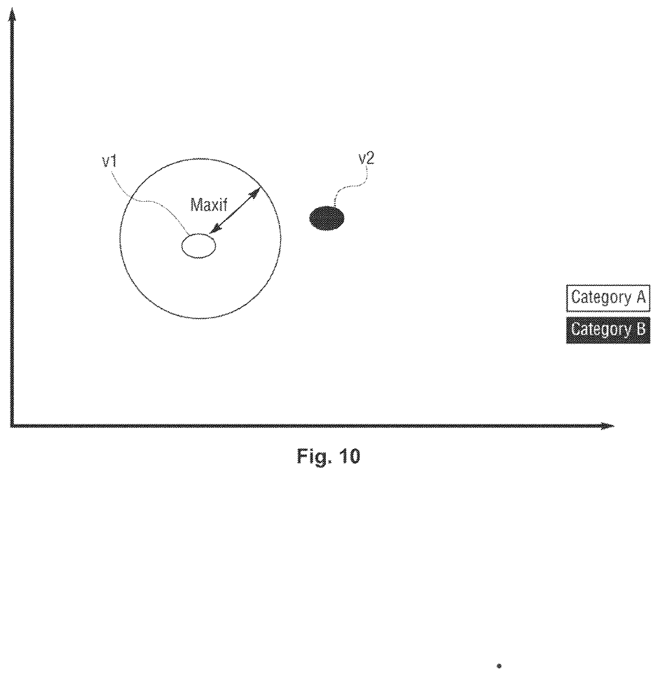

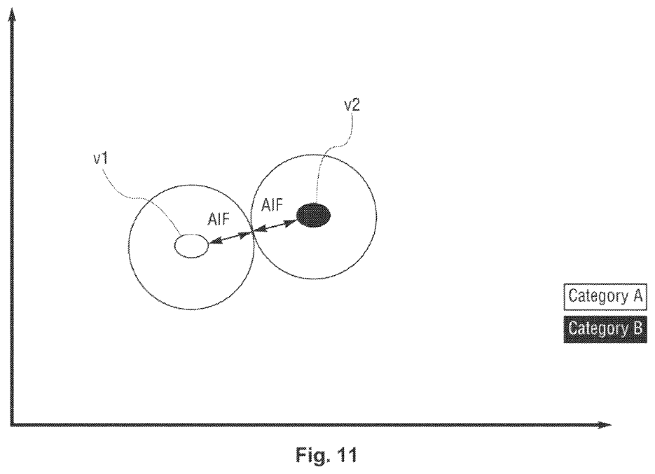

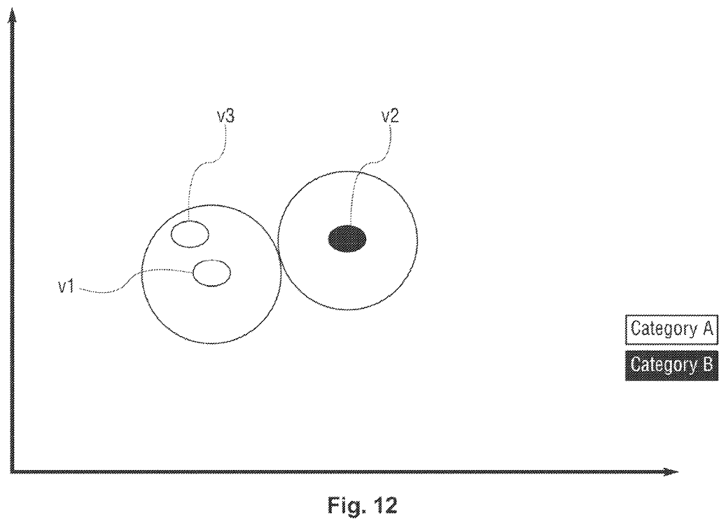

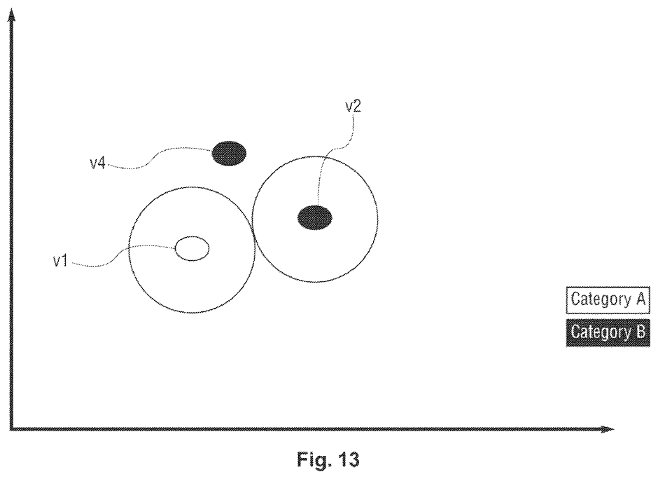

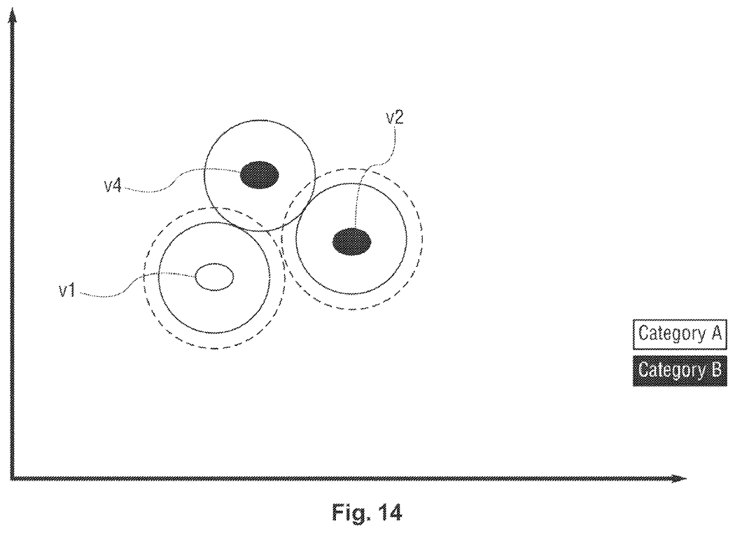

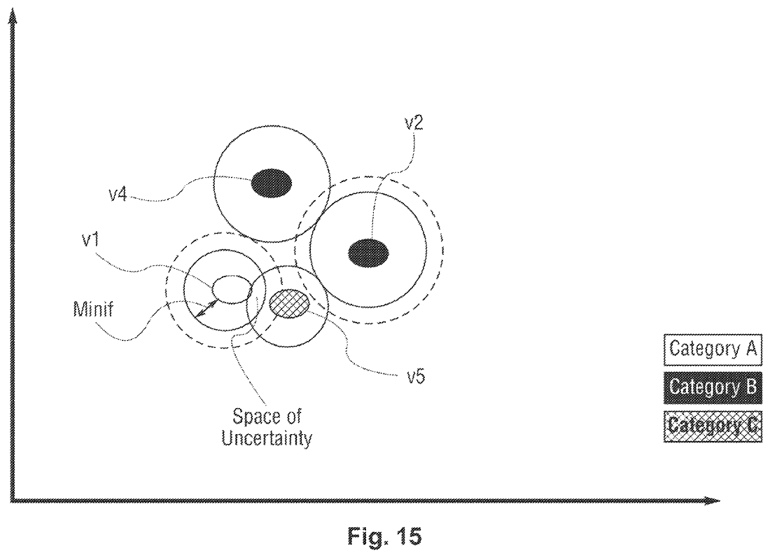

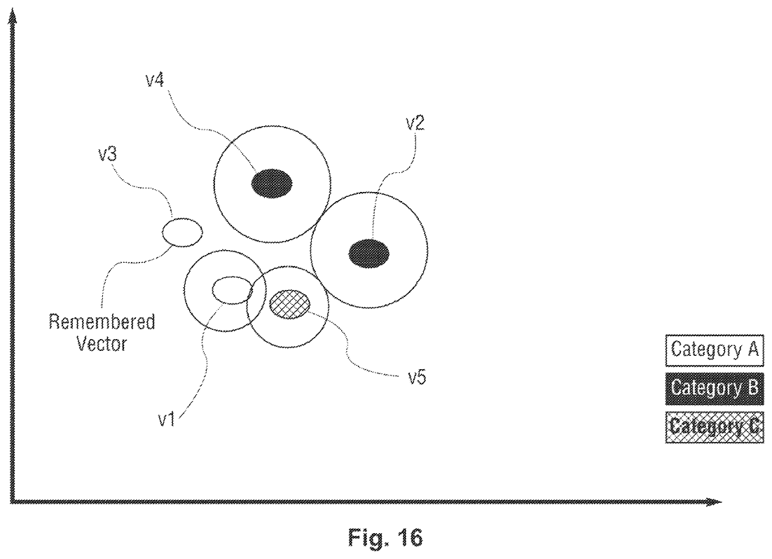

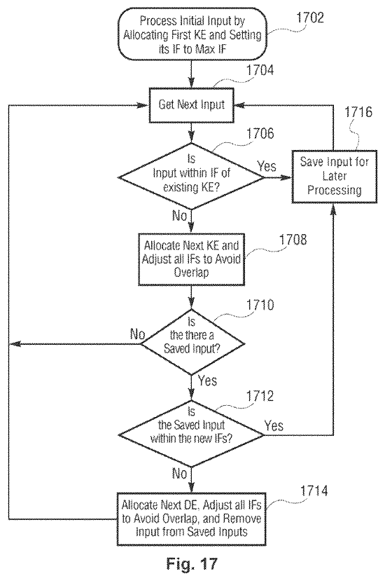

In the pattern recognition system according to some implementations, all vectors presented for learning that match against existing knowledge elements are remembered and are tried again if a subsequent learning operation reduces the influence field of any knowledge element in the array. In this way, knowledge density can be maximized to aid in increasing the sensitivity of subsequent recognition operations. This learning process is shown pictorially in FIGS. 10 through 16 for an example in a hypothetical 2-D space. FIG. 17 illustrates a method directed to the foregoing. FIG. 10 illustrates a learned vector v1 in category A and a learned vector v2 in category B. As FIG. 10 illustrates, the knowledge element corresponding to vector v1 has an influence field set to the maximum (Maxif) (see FIG. 17, 1702). Vector v2 is the next learned input vector (FIG. 17, 1704). As FIG. 11 illustrates, the influence fields of the knowledge elements for vectors v1 and v2 are adjusted to not overlap, since they have been assigned different categories (1706, 1708). In one implementation, the influence fields of each of the knowledge elements are adjusted equally to prevent the overlap. Other modes can be implemented as well. For example, the influence fields of a selected category can be favored by some weighting factor that causes the favored category to have a larger influence field. As FIG. 12 illustrates, vector v3, in the same category A as vector v1, lies within the influence field of an existing vector (again v1). Accordingly, vector v3 is initially omitted from the knowledge map in that no knowledge element is allocated, but saved for later processing (1706, 1716). FIG. 13 illustrates a vector v4 in Category B, which (as FIG. 14 illustrates) causes the influence field associated with vector v1 to be further reduced (1706, 1708). As FIG. 14 shows, in one operational mode, the influence field associated with vector v2 can also be reduced; however, in another operational mode, influence fields are adjusted only for overlapping knowledge elements in different categories. The selection of mode, in one implementation, can be another partition configuration attribute. FIG. 15 illustrates the addition of vector v5, which causes the influence field associated with vector v1 to reduce to the minimum allowed value (1706, 1708). As FIG. 16 shows, vector v3 no longer lies within the influence field associated with vector v1 and is allocated a knowledge element in the knowledge map (see FIGS. 17, 1710, 1712 & 1714).

### C.2. Half-Learning an Input Vector

In many cases, additional input knowledge is not meant to be learned (e.g., allocated a knowledge element) but rather is only used to adjust the influence fields of existing knowledge elements to make sure they would not match the input data on a subsequent recognition operation. The pattern recognition system described here does allow this; it is termed “half-learning”. With half-learning, influence fields may be adjusted, but no new knowledge elements are allocated to preserve memory resources. As shown in FIG. 18, with each input to be learned (1804), the pattern recognition engine checks whether the learn command is a half-learn command or a regular learn command (1806). If a regular learn command, the pattern recognition engine allocates a knowledge element if the vector is not within the existing influence field of a knowledge element in the knowledge map and adjusts one or more influence fields as required (1808). If a half learn command (1807), the pattern recognition engine simply adjusts one or more existing influence fields as required (1812).

### C.3. Other Enhancements

In the pattern recognition system, the specific identifier, e.g. number, of the matched knowledge element (e.g., array index) is returned for all matched knowledge elements. Thus if an application keeps track of which knowledge element identifiers are allocated when training the knowledge element array, these identifiers can be used when matches occur to reference back to the source of the initial training knowledge, possibly in conjunction with the opaque user data, as described above. The ability to determine the precise knowledge elements which caused a match can be quite useful to a variety of applications. For example, the knowledge elements that did not cause a match may possibly be excluded when developing a knowledge map for the same application in order to save memory space and processing power.

Still further, the pattern recognition system may also maintain user and system counters for each knowledge element. A system counter is incremented each time a knowledge element is matched to an input vector. A user counter is incremented each time a knowledge element is matched to an input vector and when one or more user-defined rules are satisfied. In this manner, the significance of the trained knowledge elements can be assessed. For example, when developing a pattern recognition system for a specific application, such as machine vision in an auto assembly line, the system may be initially trained with 250,000 knowledge elements. Use of the system in a testing environment and analysis of the system and user counters may reveal, for example, that only 100,000 knowledge elements were ever matched and that many of the matched knowledge elements had an insignificant number of matches. An engineer may use this knowledge when implementing the field version of the pattern recognition system to exclude large numbers of knowledge elements, thereby reducing resources (processing and memory) for the given machine vision application.

In the prior art, it was not possible to delete existing knowledge if it was determined that that knowledge was in error. The only approach was to delete all the knowledge and retrain the knowledge element array again and not include the errant knowledge. This took time and required that the original knowledge be retained for subsequent training operations. The pattern recognition system, according to some implementations, allows individual knowledge elements to be deleted (cleared and marked as available) if it is determined that the knowledge they represent is in error. In addition, subsequent learning operations will use the knowledge elements previously deleted (if any) before the free knowledge element block at the end of the knowledge element array is used. When a knowledge element is deleted, it also triggers a reapplication of the “not learned knowledge,” if any (see Section D.1., above).

In addition, the pattern recognition system can also support configurable weighting values that can be selectively applied to knowledge elements of one or more categories to bias selection of for or against that category as to one or more input vectors. For example, the weighting factor can be used to increase the influence fields of RBF knowledge elements or to adjust the resulting aggregate distance computed between an input vector and a knowledge element vector. Again, this may be another configuration parameter for a partition.

In one implementation, the pattern recognition system supports a mode where a knowledge map is held static. For example, in a first dynamic mode, a given knowledge map can be augmented and changed as it is trained with new knowledge. The pattern recognition system also supports a static mode that disables further learning as to a select knowledge map. The fixed size (or further learning disabled mode) can be used to disallow knowledge updates which could cause non deterministic results when two similarly configured machines are modified independent of one another. In one implementation, the commands to enter and exit this mode may require an administrative password to allow for periodic updates, while protecting the knowledge map from updates by unauthorized personnel or applications.

As noted above, the pattern recognition system is implementation-agnostic and can be implemented using software in a general-purpose computing platform. Moreover, as noted above, the pattern recognition system is also amenable to implementation in firmware, hardware (FPGA or ASIC), combinations thereof, etc.

### D. Extendable System Architecture

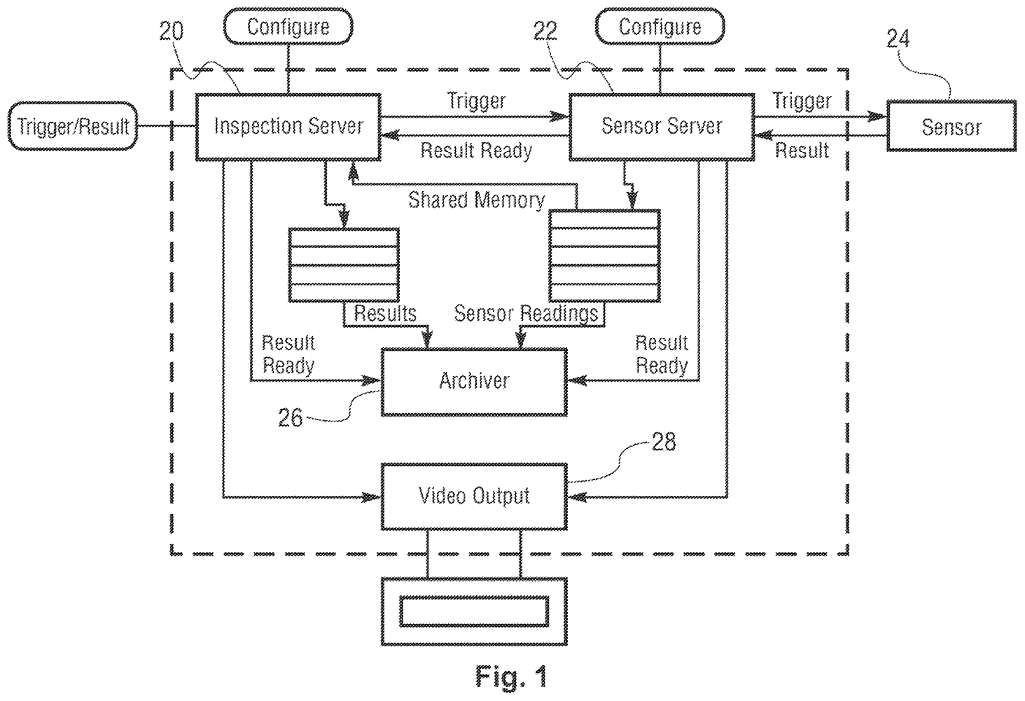

FIG. 1 illustrates an example functional system architecture according to one possible implementation of the pattern recognition system. In this example implementation, the pattern recognition system includes two software-based servers that use the same shared memory. One of the servers is the sensor server 22, which initiates a trigger and then receives sensor readings from a sensor 24 (e.g., image, video, audio, chemical, text, binary, etc.). The other server is the inspection server 20 which triggers and receives results from the sensor server 22. As shown in FIG. 1, both the sensor server 22 and the inspection server 20 can be configured by a human (using for example a USB storage device or a network) or an automated user of the pattern recognition system. In the event that the pattern recognition system includes data sensors that are sensing data of different types (e.g., image and audio, radio frequency), the pattern recognition system might include another software- or hardware-based server (not shown), on the same system or possibly connected via a network (not shown), which combines the results of individual inspection servers to create a higher level or hierarchical result, as described in greater detail earlier. In the subject pattern recognition system, this is termed “sensor fusion”.

Additionally, as shown in FIG. 1, the pattern recognition system may include an archiver 26, where the system stores, (locally or remotely) among other things, results from the inspection server 20 and sensor readings from the sensor server 22. Also, as shown in FIG. 1, the pattern recognition system may optionally include a video output device 28 of some type, for display to a human user.

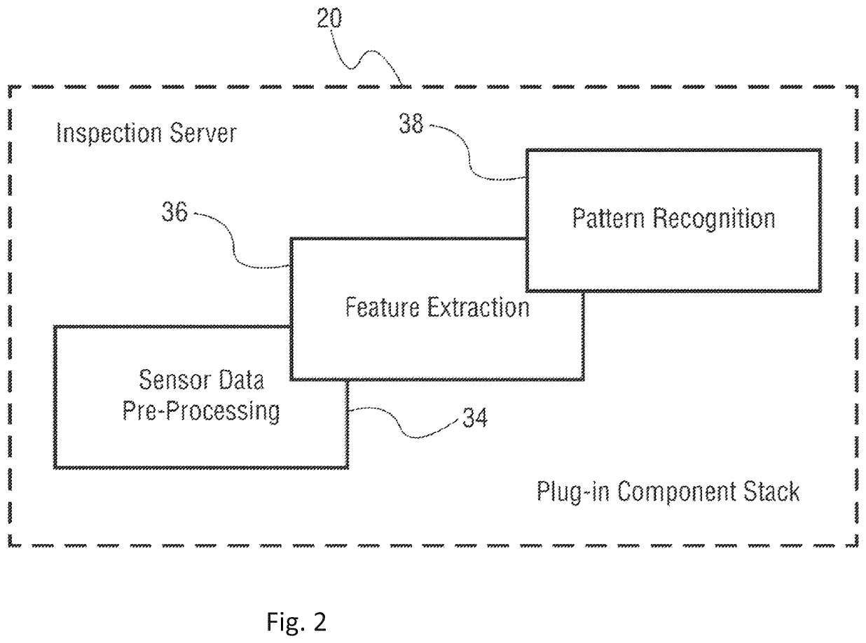

The pattern recognition system includes logic for pattern identification and pattern recognition, which logic is described in detail in this document. That logic, in one implementation, resides in the inspection server 20 shown in FIG. 1. In some implementations, the pattern recognition system is a scalable system whose resources can be increased as needed. Also, in some implementations, the pattern recognition system is an extendable system, whose functionality can be readily extended via the use of general-purpose and special-purposes components. In one implementation, the pattern recognition system is extendable using a set of plug-in components relevant to the task at hand, e.g., machine vision utilizing feature extraction. By choosing the order a particular plug-in component is used during task performance, it is possible to control when invocation occurs with respect to the system logic for pattern identification and pattern recognition. FIG. 2 illustrates an example implementation including a sensor data pre-processing component 34, a feature extraction component 36, and a pattern recognition component 38. See also FIG. 6, which illustrates that the pattern recognition system may take inputs from several feature extraction components during a machine vision task. Preprocessing of the sensory data may be performed prior to attempting pattern recognition and feature extraction. For example, if the task at hand is machine vision, this preprocessing might include filtering to reduce noise, improve resolution, convert to grayscale, etc.

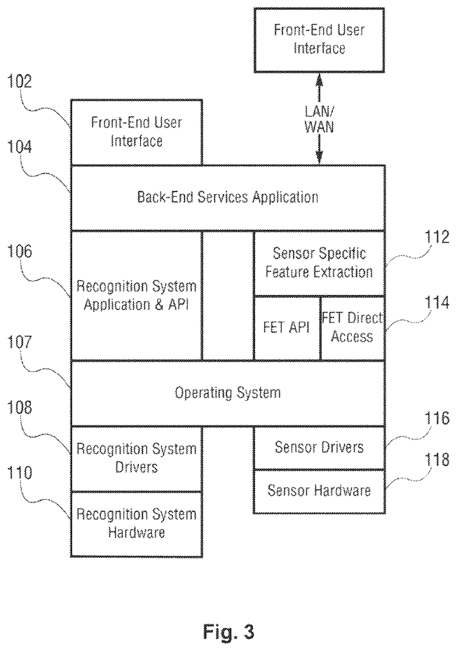

FIG. 3 is a more detailed picture of a possible component stack that includes feature extraction (FET) functionality. Operating system 107 may be any suitable operating system, e.g. Linux®, Windows® XP. As FIG. 3 illustrates, sensor drivers 116 may provide an API and command layer to sensor hardware 118. Feature extraction and sensor specific feature extraction API layers 112, 114 provide an interface to sensor drivers 116 via operating system 107 and may include functionality operative to pre-process raw data provided by the sensor hardware 118 to extract one or more features or attributes. As discussed below, pattern recognition processing may be offloaded to dedicated recognition system hardware 110, which may for example be a field programmable gate array (FPGA) or other programmable logic circuit implemented on a PCI or other card. Recognition system drivers 108 provide application programming interfaces to the hardware 110, while recognition system application and application programming interface (API) layer 106 provides interfaces to one or more pattern recognition applications (such as back-end services application 104). Back-end user services application 104 is operative to receive sensor input data and provide the input data, via recognition system application and API layer 106 to the recognition system hardware 110 for matching operations. Front-end user interfaces 102, 103 provide user interfaces to facilitate interaction with the pattern recognition system, such as configuration tasks, management tasks, and monitoring tasks.

A pattern recognition system can be hardware or software implementation-agnostic. That is to say, one can implement the pattern recognition system using: (1) software on an existing processor (e.g., Pentium, PowerPC, etc.), as indicated by the API in Appendix A; (2) HDL code for an FPGA (e.g., Xilinx Virtex-4, Altera Cyclone 3); (3) HDL Code in a semi-custom area of an existing generic processor (e.g., IBM Cell(REF)); and (4) full custom Application Specific Integrated Circuit (ASIC). In the case of chip-level implementations (e.g., 2-4 above), the chip might be mounted on a printed circuit board (PCB). This PCB could be on the main PCB for a computing machine or as an expansion PCB which would plug into an interconnect bus (PCI, PCI Express, etc.).

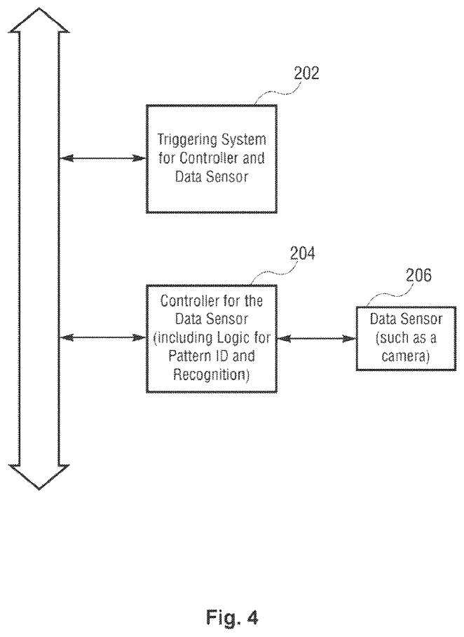

FIG. 4 shows an implementation where the pattern recognition system runs, and/or is integrated with, a controller 204 for a data sensor 206, which, e.g., might be a camera if the task to be performed is machine vision. More generally, a data sensor 206 is a device that contains one or more transducers that captures observed physical phenomena, such as sounds, images, radio-frequency signals, etc., and converts them into an analog or binary representation for digital processing of the sensed data. Further, in this implementation, there might be multiple controllers 204 for multiple data sensors 206, of the same or different types, e.g., a controller for a camera and a controller for a thermal imaging device, such as an infrared camera. Additionally, a triggering system 202 may trigger operation of the data sensor 206 and controller 204, such as when a new part is ready for inspection on an assembly line; or results may be presented asynchronously based on sensor readings.

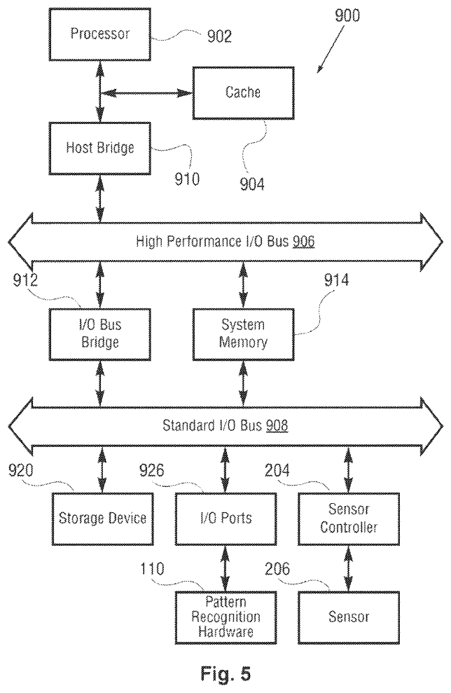

FIG. 5 illustrates for didactic purposes a general-purpose computing platform, and hardware architecture, which might use the sensor controller 204 shown in FIG. 4. In this implementation, hardware system 900 includes a processor 902, a system memory 914, sensor controller 204, and one or more software applications and drivers enabling the functions described herein.

Further in FIG. 5, hardware system 900 includes processor 902 and a cache memory 904 coupled to each other as shown. Cache memory 904 is often of two levels, one which is contained as a part of processor 902, and one which is external to processor 902. Additionally, hardware system 900 includes a high performance input/output (I/O) bus 906 and a standard I/O bus 908. Host bridge 910 couples processor 902 to high performance I/O bus 906, whereas I/O bus bridge 912 couples high performance I/O bus 906 and standard I/O bus 908 to each other.

Coupled to bus 906 are sensor controller 204, such as a camera system controller, and system memory 914. A sensor 206 is operably connected to sensor controller 204. The hardware system may further include video memory (not shown) and a display device coupled to the video memory (not shown). Coupled to standard I/O bus 908 bus 908 are storage device 920 and I/O ports 926. Collectively, these elements are intended to represent a broad category of computer hardware systems, including but not limited to general purpose computer systems based on the Pentium® processor manufactured by Intel Corporation of Santa Clara, Calif., as well as any other suitable processor.

The elements of hardware system 900 perform their conventional functions known in the art. Storage device 920 is used to provide permanent storage for the data and programming instructions to perform the above described functions implemented in the system controller, whereas system memory 914 (e.g., DRAM) is used to provide temporary storage for the data and programming instructions when executed by processor 902. I/O ports 926 are one or more serial and/or parallel communication ports used to provide communication between additional peripheral devices, which may be coupled to hardware system 900. For example, one I/O port 926 may be a PCI interface to which an FPGA implementation of the pattern recognition system hardware 110 is operably connected.

Hardware system 900 may include a variety of system architectures, and various components of hardware system 900 may be rearranged. For example, cache 904 may be on-chip with processor 902. Alternatively, cache 904 and processor 902 may be packed together as a “processor module,” with processor 902 being referred to as the “processor core.” Furthermore, certain implementations of the claims may not require nor include all of the above components. For example, storage device 920 may not be used in some systems. Additionally, the peripheral devices shown coupled to standard I/O bus 908 may be coupled instead to high performance I/O bus 906. In addition, in some implementations only a single bus may exist with the components of hardware system 900 being coupled to the single bus. Furthermore, additional components may be included in system 900, such as additional processors, storage devices, or memories.

As noted above in connection with FIG. 3, there are a series of application and driver software routines run by hardware system 900. These software routines comprise a plurality or series of instructions to be executed by a processor in a hardware system, such as processor 902. Initially, the series of instructions are stored on a storage device, such as storage device 920. However, the series of instructions can be stored on any conventional storage medium, such as a diskette, CD-ROM, ROM, EEPROM, flash memory, etc. Furthermore, the series of instructions need not be stored locally, and could be received from a remote storage device, such as a server on a network. The instructions are copied from the storage device, such as storage device 920, into memory 914 and then accessed and executed by processor 902.

An operating system manages and controls the operation of hardware system 900, including the input and output of data to and from software applications (not shown). The operating system and device drivers provide an interface between the software applications being executed on the system and the hardware components of the system. According to, the operating system is the LINUX operating system. However, the described implementations may be used with other conventional operating systems, such as the Windows® 95/98/NT/XP/Vista operating system, available from Microsoft Corporation of Redmond, Wash. Apple Macintosh Operating System, available from Apple Computer Inc. of Cupertino, Calif., UNIX operating systems, and the like. Of course, other implementations are possible. For example, the functionality of the pattern recognition system may be implemented by a plurality of server blades communicating over a backplane in a parallel, distributed processing architecture. The implementations discussed in this disclosure, however, are meant solely as examples, rather than an exhaustive set of possible implementations.

### E. Implementation Using Programmable Logic Circuit

As indicated above, the pattern recognition engine can be implemented as software on a standard processor or in connection with a semiconductor circuit including a programmable logic circuit, such as a field programmable gate array. In such an implementation, a driver layer (see FIG. 3, above) allows an application to pass commands (e.g., learn, recognize, etc.) to the FPGA, which implements the pattern recognition engine that maintains the knowledge maps and partitions. The benefits of the semiconductor version is the speed of pattern identification for larger knowledge maps (real-time or near real-time) and to off load the host processor. Also in some cases the semiconductor implementation can be used for embedded applications where a standard processor could not.

In one possible FPGA implementation, the pattern recognition engine is installed on a printed circuit board or PCB (which will normally be connected via an interconnect bus, e.g., PCI, PCI-Express, etc.). In one implementation, the FPGA unit is operative to receive an input or test vector, and return an identifier corresponding to a matching knowledge element or a category (and possibly opaque user data) associated with the matching knowledge element. In one implementation, each FPGA pattern recognition unit is a PCI device connected to a PCI bus of a host system.

Sensor reading or polling, sensor data processing and feature extraction operations could be offloaded to a co-processor or developed as an FPGA (or other programmable logic circuit) implementation and installed on a programmable logic circuit. Feature extraction is discussed above. Sensor data processing may involve one or more operations performed prior to feature extraction to condition the data set prior to feature extraction, such as pixel smoothing, peak shaving, frequency analysis, de-aliasing, and the like.

Furthermore, as discussed above, the comparison techniques (RBF, KNN, etc.), distance calculation algorithms (L1, LSup, Euclidian, etc.) can be user configurable and plugged in at runtime. In one programmable logic circuit implementation, the selected pluggable algorithms can be stored as a set of FPGA instructions (developed using VERILOG or other suitable SDK) and dynamically loaded into one or more logic units.

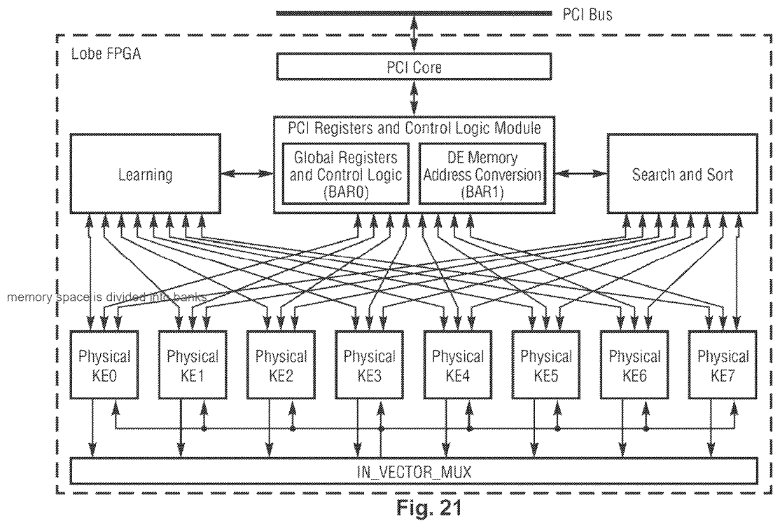

FIG. 21 below shows such an implementation. In this implementation, a Xilinx Spartan-3 family xc3s400 FPGA is configured to implement eight (8) physical knowledge element (KE) engines which interface with block memory to implement the total knowledge element count for the various vector widths. In this regard, the pattern recognition system could incorporate multiple FPGAs, similar to the FPGA described above, and control logic, possibly embodied in hardware or software, to coordinate operation of the multiple FPGAs.

The PCI Registers and control logic module includes registers that are used to configure the chip, and return the status of the chip. The module, in one implementation, includes a memory space for storing data (such as knowledge maps) and configuration information (such as partition information). In one implementation, the memory space is divided or allocated for different aspects of the pattern recognition system. A first memory space includes a set of registers, used in the learning and recognition phases, for the input vector, status information, configuration information, as well as information on matched knowledge elements (or setting of a newly created knowledge element in a learning operation). The matching knowledge element information can include a knowledge element identifier, an actual influence field, a minimum influence field, knowledge element status information (including whether it fired relative to an input vector), a category identifier, a partition, a distance value, and the like.

A second memory space provides for a knowledge element (KE) memory space, for virtual decision elements, allocated among the physical knowledge element engines. In one implementation, a second memory space is for knowledge element information. In one implementation, this memory space is divided into banks. Each bank is further divided into areas for knowledge element registers, and knowledge element vectors. One to all the banks may also include an area for storing one or more input vectors or portions of input vectors. Each virtual knowledge element, in one implementation, has its own set of registers in the knowledge element register, including for example, knowledge element identifiers, actual influence field, minimum influence field, partition identifier, category identifier, one or more distance field register that indicates the distance between an input vector and the corresponding learned vector of the virtual knowledge element. Each bank of the second memory space also stores the learned vectors for each of the virtual knowledge elements allocated to it. The maximum number of learned vectors and knowledge elements in each bank is determined by the vector width. The control module, in one implementation, provides a memory address conversion for the knowledge element memory, as well as the de-multiplexer for read back. In one implementation, the second memory space also provides for storage of one or more input/test vectors. Of course, the memory space may be divided and arranged in a variety of configurations.

In one implementation, a learning module performs various learning operations, such as scanning all the existing knowledge elements, adjusting the existing knowledge element influence fields, setting category identifiers, finding the minimum distance to different category knowledge elements, and creating a new knowledge element if needed. In one implementation, the learning module can implement the learning functionality described above. The circuit may also include a multiplexer that provides a given test vector to the respective physical knowledge element engines. In one implementation, a physical knowledge element includes logic to compute the distance between a test vector and the learned vectors corresponding to the virtual knowledge elements to which the physical knowledge element has been assigned. In one implementation, each physical knowledge element engine is further operative to search for the minimum computed distance among the virtual knowledge elements to which it has been assigned. In one implementation, each physical knowledge element operates on an input vector to identify an assigned virtual knowledge element having the minimum distance to the input vector. In one implementation, the FPGA is a parallel processor in that the physical knowledge elements operate in parallel. In one implementation, each physical knowledge element computes a distance using an input vector and writes the computed distance to a distance register of the corresponding virtual knowledge element. The logic of the physical knowledge element is operative to return the knowledge element information corresponding to the virtual knowledge element having the minimum distance to the input vector. In one implementation, the control logic is operative to identify the virtual knowledge element having the overall minimum distance identified across the multiple physical knowledge element engines. In one implementation, the pattern recognition system provides results at each interconnect bus cycle. That is, on one interconnect bus clock cycle the input data vector or vectors are loaded across the bus and on the next bus cycle results are ready.

Given this bus clock cycle overhead, 100% parallelism in the knowledge elements is no longer required. Rather the pattern recognition system leverages the limited FPGA resources to implement the virtual knowledge elements. Using a virtual knowledge element approach, a plurality of physical knowledge element engines are implemented in the FPGA, each of which may relate to multiple virtual decision elements. Specific knowledge element contents would be stored in the FPGA memory to allow many hundreds of virtual knowledge elements to be implemented across a lesser number of physical knowledge element engines. These virtual KEs operate in a daisy chain or round-robin approach on the FPGA memory blocks to implement the total KE count coupled with the real, physical knowledge elements that are constructed in the FPGA's gate array area. Each virtual knowledge element has its own influence field. When learning causes a new virtual knowledge element to be allocated, the allocated virtual knowledge element number is returned. When a match occurs in the recognition phase, the firing virtual knowledge element number is returned. A 32-bit register can be implemented in each virtual knowledge element. This register can be written in learning phase. The value will be returned in the recognition phase unchanged. An application has full access to the virtual knowledge element memory space. The application can save the knowledge element network to hard disk and later reload the knowledge element network into the FPGA. The user can modify the knowledge element network according to their special need at any time except while a learning or recognition operation is in process. Through this interface knowledge elements can also be deleted if desired.

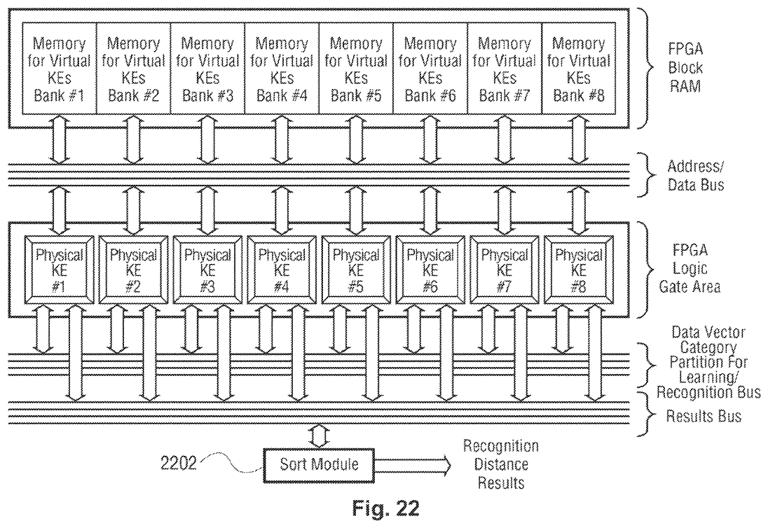

FIG. 22 below shows how these virtual knowledge elements relate to their physical counterparts in one possible FPGA implementation. FIG. 22 depicts a sort module 2202 used in some implementations of the FPGA. In a recognition operation, each physical knowledge element engine (Physical KE) measures the distance of all the matches for the virtual knowledge elements (Virtual KE) that it controls, and rank orders them by distance. This information is made available to a higher level functional circuit which combines the results of the physical knowledge element engines to create the final overall result.

Additionally, in the FPGA implementation, the pattern recognition system can be implemented using a pipeline approach as many data vectors can be loaded in a single interconnect bus clock cycle thus further speeding the overall result time for many data vectors needing identification. That is, the pipeline may increase the effective speed of recognition performed by the FPGA.

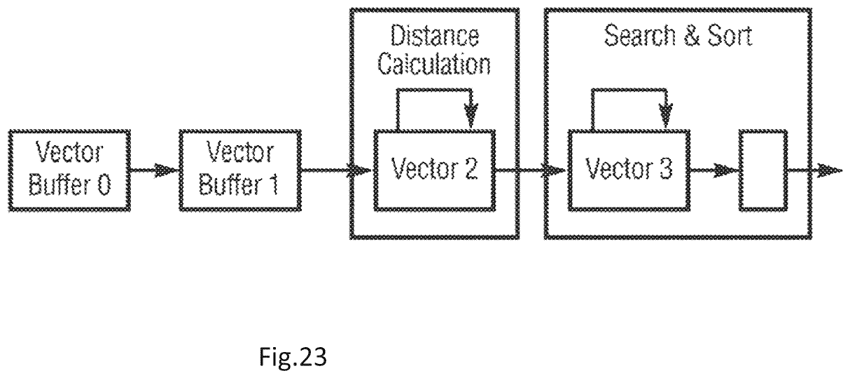

As shown in FIG. 23, the pipeline has 3 stages: 1) search and sort; 2) distance calculation and 3) vector buffers. Four input vectors can be stored in the FPGA. The vectors are processed first in-first out. When the Buffer Ready flag is set, it means that vector buffer 0 is empty. The user (e.g., the programmer) can write a vector into the FPGA. The input vector written into the FPGA, in one implementation, is written into buffer 0. After the last byte of the vector is written, vector buffer 0 will be locked (not ready). When the next stage is empty, the vector will move forward, and Buffer 0 will be empty (ready) again. Writing a vector into the FPGA while buffer 0 is not ready will cause an error. Setting NEXT VECTOR flag will push the vector at the search and sort stage out of the pipeline. The other vectors in the pipeline will move forward.

The RESET flag can be used to remove all the vectors in the FPGA. With this mechanism, two vectors can be processed at same time, where a distance calculation is performed relative to one input vector, while a search and sort operation can be performed relative to a second input vector. In addition, while waiting for the result, software can write other vectors into the FPGA. In addition, while waiting for the minimum distance to be read out, a next minimum distance can be searched.

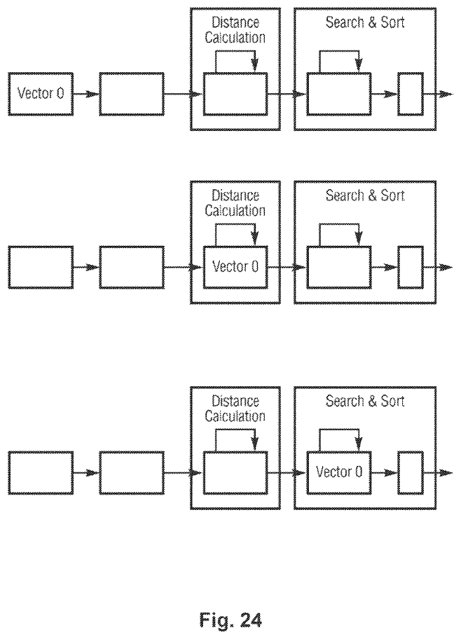

For the application software, reading results and writing vectors can be performed in two separate threads. When the Buffer Ready is set, the application can write a vector into the FPGA. When the Ready flag is set, the application can read the result out. Read knowledge element number and distance will trigger hardware to search for the next matched knowledge element. To process the next vector, the application can set the NEXT VECTOR flag. The first input vector just flows through to the end and sets the status flag when the results are ready. This is shown in FIG. 24.

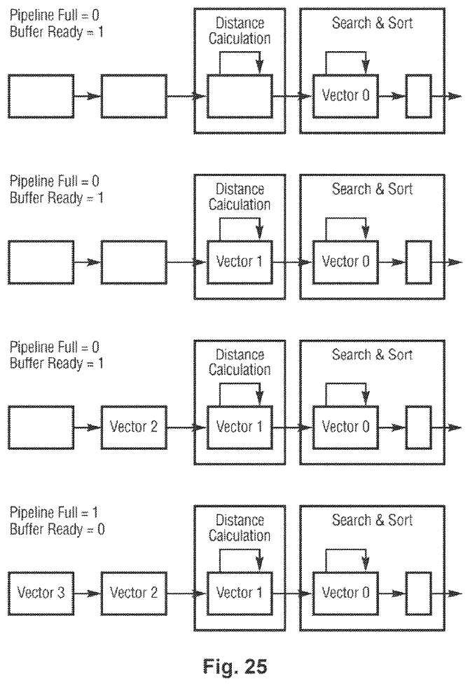

When the application needs to process vectors one by one, the user can write the vector in, and wait for the result. After this vector has been processed, the application can set the NEXT VECTOR flag to remove this vector from the pipeline, and then write the next vector in. The next vector will flow through to the end just like the first vector. If the user doesn't set the NEXT VECTOR flag to remove the front end vector, the second input vector will flow through to the distance calculation stage, and the third vector will wait in the vector buffer 1. They will not push the first vector out, as illustrated in FIG. 25.

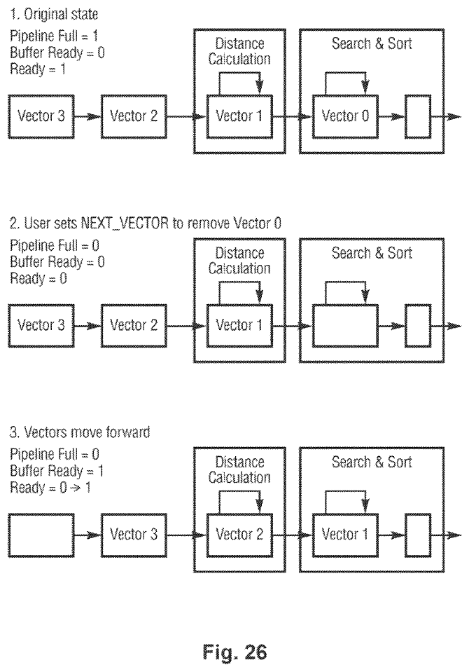

When the pipeline is full, the application sets the NEXT CONFIG flag to remove the front end vector out of the pipeline before writing another vector in. All the other vectors will move forward. For example, as shown in FIG. 26, vector 0 will be pushed out, vector 1 will move into search and sort stage, the vector in buffer 1 will move to the distance calculation stage. Buffer 0 will be empty. The Buffer Ready flag will be set again.

To recapitulate with respect to pipelining, vectors can be written into the vector buffer when vector buffer is empty. When the distance calculation stage is free, the vector in the vector buffer 1 will be moved forward, and vector buffer 1 will be left free for next vector. When the distance calculation is finished, and the search & sort stage is free, the vector will be moved forward (actually it will be discarded). The minimum distance will be searched, and copied to the output buffer. Next the minimum distance will be searched while waiting for the minimum distance to be read. The vector at Search & Sort stage will be discarded when software writes another vector into the FPGA.

As is relevant to the partitions discussed above, given the structure of the FPGA block RAM according to one possible implementation, four different vector widths (32/64/128/256—bytes) can be supported, which in turn, result in four different virtual KE counts (672/400/224/112). Thus, an application can choose the width and count most appropriate to the task at hand. Of course, other FPGA implementation may allow for different vector widths and

Finally, physical knowledge elements might be loaded with different distance calculation algorithms for different requirements. Thus, the FPGA can be configured to allow all physical knowledge elements to use the same recognition math or algorithm. Alternatively, each physical knowledge element can be configured to use a different math, e.g., L1 or LSUP. Or further still, the math for the physical knowledge elements can be swapped in/out based on the partition chosen for pattern identification and the partition's associated “math” requirements.

Some implementations of the anomaly detection engine described below are configured to monitor a series of input vectors, and with minimal computation resources, construct a model of the data. The low computational power required for establishing the data model enables the system to operate in real-time using low-cost processors or other suitable hardware. Once the data model is established, the anomaly detection engine classifies new incoming input vectors or a sequence of vectors as ‘normal’ or as an ‘anomaly’.

In addition, the new incoming input vectors can be processed to dynamically modify the data model, in some instances, in a continuous fashion. For example, the anomaly detection engine may be used to monitor sounds and vibrations of a motor. As the motor's temperature changes (starting from cold start to normal operating temperature), the sounds and vibrations which are represented by one or more input vectors may be slowly changing their appearance. Some implementations of the disclosed anomaly detection engine can dynamically update the underlying data model KEs and adapt characteristics as to recognize the normal changes as ‘normal’ data inputs, while maintaining ability to detect changes caused by malfunctioning operation of the motor.

Some implementations described below operate as an unsupervised anomaly detection system utilizing unlabeled data, while some other implementations also utilize labeled data (supervised-unsupervised hybrid). The unsupervised implementations described below assume that most observations are normal. Hybrid implementations can ensure that the knowledge map is initialized on normal data. Furthermore, at any time, labeled observations may be given to the model to provide class recognition in addition to anomaly detection. This recognition is facilitated by using KE(s) to designate classes as regions of a feature vector space without interfering with anomaly detection.

Distance within the feature vector space is utilized to identify anomalous data points as those distant from the majority. The “normal” data vectors are assumed to be the majority of data vectors while the “abnormal” data vectors are those spatially distant from the rest. A second class of anomaly may be identified as the distribution of vectors within a sequence being sufficiently different to those of previous vectors.

Anomaly detection can be applied to online or offline data. In online operation, continuous, streaming data are introduced to the model in an iterative fashion. Commonly the data is introduced as soon as it is available and there is a desire for processing to be fast enough to keep pace with the rate of data generation. In offline operation, processing of historical data often is conducted in batches. The implementations described below assume online learning but could be applied offline without modification as well. Along with processing speed and volume of data, dimensionality of data presents a third obstacle. The methods and implementations described herein are configured to address all three of these factors.

Metadata Associated with a Knowledge Element (KE)

As explained above, each KE can have associated metadata. For some implementations, some of the data elements of the metadata are explained below. Other elements may be associated with each KE as desired.

Age: The age of each KE is an index counter indicative of the total number of input vectors seen by the system since the KE was instantiated.

Hit: The occurrence of an input vector falling within the influence distance of a given KE.

Hit count: The hit count maintains a count of the number of input vectors that fell within the influence distance from the KE. In accordance with some implementations, if an input vector falls within the influence distance of more than one KE, only the closest KE's hit count is incremented. In accordance with some other implementations, the hit count of all of the KEs are incremented.

Quality (Q): Indicative of how common it is for an input vector to fall within the ID of a specific KE.

Weight quality: The weight quality is an average of distances between a KE and the input vectors within an influence distance. The weighted quality of a specific KE brings into account the average distance of hits from this KE.

Hit History: The hit history tracks the sequence of hits including the distances that occurred for each test vector. In accordance with some implementations, model misses are vectors that do not hit existing KEs, and hence create KEs. In some implementations, each KE has an integer hit count. In some other implementations, the partition holds a queue that points to the KE hit or says that it is a KE itself (a miss). As part of the metadata, the KEs can track the average distance of hits without keeping in memory all the hit distances of the various test vectors. In accordance with some implementations, model misses are considered retroactively. Each KE has a queue holding the distance to the hit vector once the partition ID is updated (reduced in size), these entities in the queues are re-evaluated to determine if previous hits are now misses.

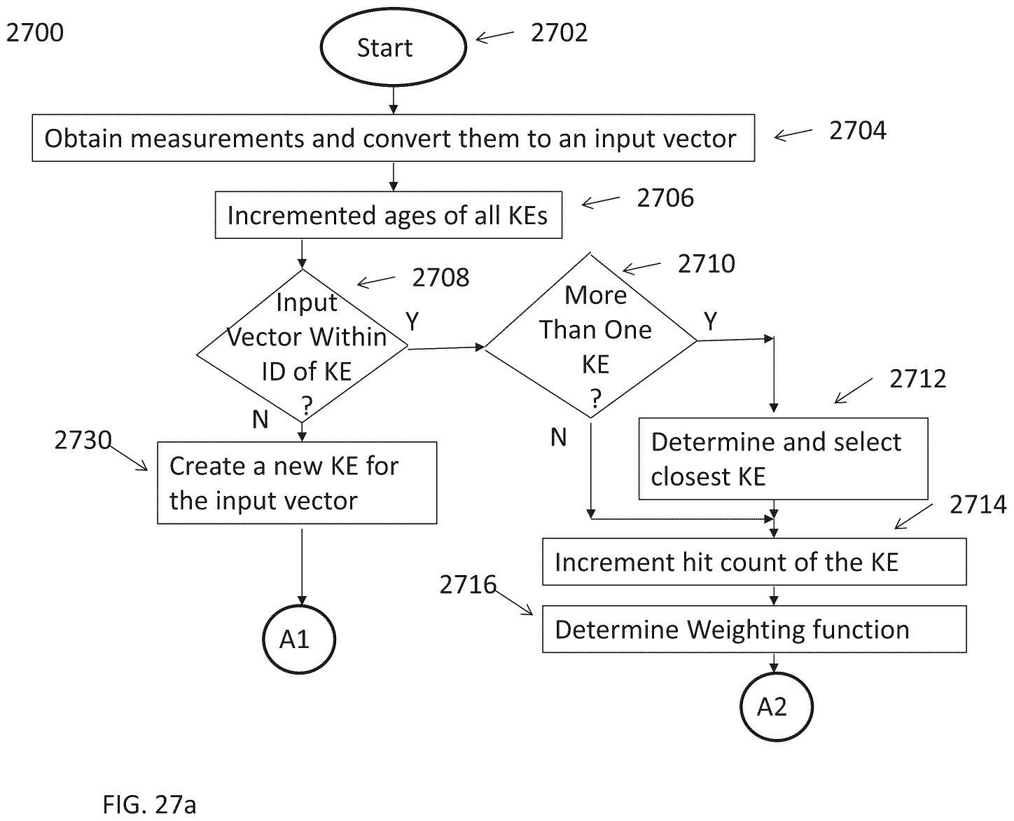

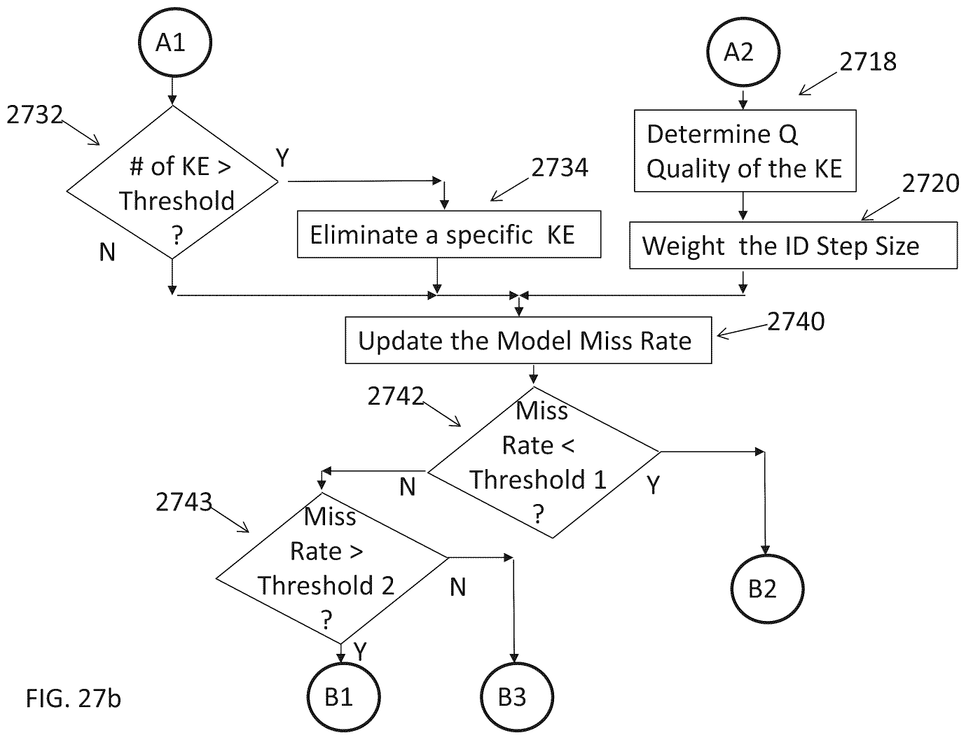

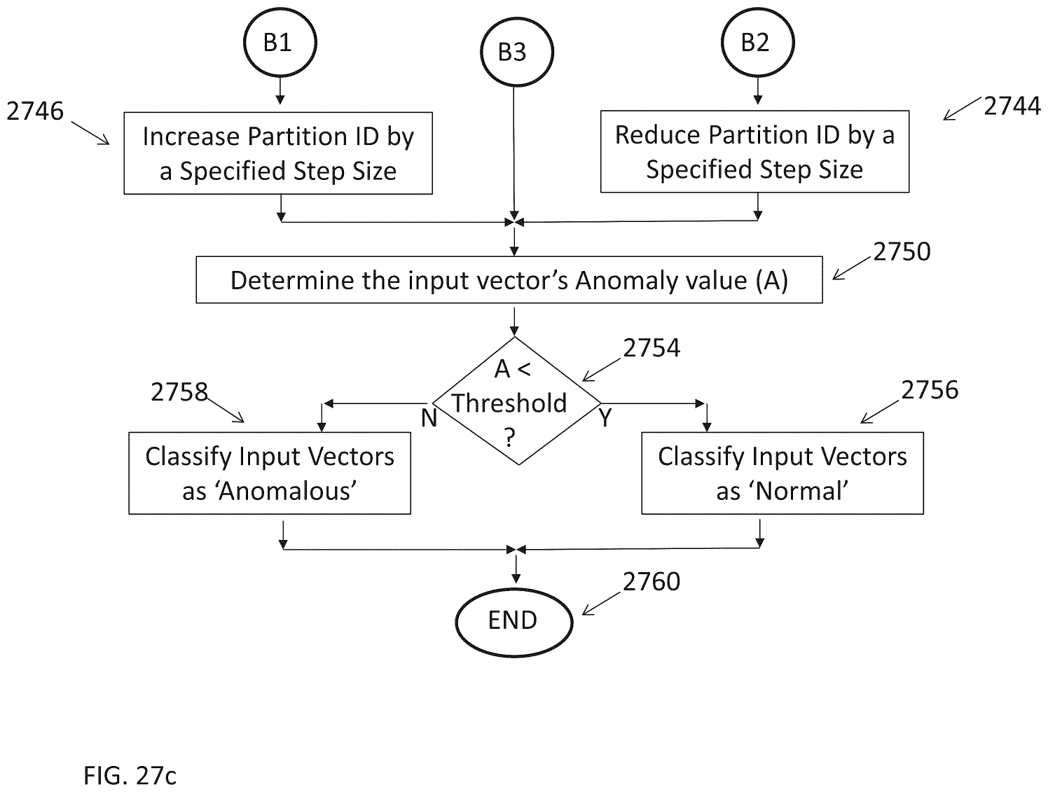

Referring to FIGS. 27a-c, a flow chart 2700 starts at operation 2702 and proceeds to operation 2704 where the system obtains measurements and converts them to an input vector. In accordance with some implementations, the system collects data streams from sensors associated with an observed system. Each set of measurements or observations is mapped into an n-dimensional vector. In some implementations, the vector may be pre-processed such as to reduce any noise components or interferences introduced in the measurement process. In some other implementations, the vector information may be obtained in the time domain and if indicated transformed into the frequency domain using algorithms such as Fast Fourier Transformation (FFT). An appropriate window, e.g., Hamming window may be applied to the data before processing it via the FFT. The resulting output from the FFT processing is indicative of the frequency component of the input data.

The time series of the raw measured data vectors (in the time domain) or the FFT transformed vectors (in the frequency domain) are used as an input into the anomaly detection engine. We will refer to these vectors as “Test Vectors” or “Input Vectors”.

Upon arrival of each new input vector, the ages of all KEs are incremented (2706). In accordance with some implementations (not shown for sake of simplicity), if the age of any KE exceeds a predetermined threshold, e.g., max allowed age, the KE age does not change.

In operation 2708, the method determines whether the input vector falls within an influence distance (ID) of any existing KE. The value (size) of the KE is initially initialized to a predetermined value, or alternatively the value is set by the user. As described in greater detail below, as the system processes additional input vectors, the value of the ID is dynamically adjusted by the system. In accordance with some implementations, during the initialization phase the value of the ID is set to be proportional to the average distance between n input vectors. While this method produces ID value after processing the first two input vectors, a more relevant ID value for the distribution of the input vector data is obtained after processing a larger number of input vectors, e.g., 10 or 100 vectors. For sake of simplicity, the process of determining the value of the ID is not illustrated in this figure. If the input vector falls within the influence distance of more than one KE (2710), the method calculates the distances between the input vector and all of the KE for which the input vector fell within their influence distance. The KE closest to the input vector is determined in operation 2712 to be the “hit” or the KE to which the input vector belongs. Once the KE to which the input vector belongs is determined (either by operation 110 if input vector fell within the ID of a single KE, or operation 112 if the input vector fell within the ID of multiple KEs), the input vector is classified as a hit for the KE closest to the input vector and the hit count of that KE is incremented (2714).

Operation 116 determines (calculates or updates) a weighting function for the identified KEs.

In some implementations, the weight (W) of a KE is defined by:

Wᵢ=(ID−avg_dist_of KE's_hits to KEᵢ)/ID Equ. 1a

Wᵢ=1−(avg_dist_of_KE's_hits to KEᵢ)/ID Equ. 1b
Where:
Wᵢ—weight of KEᵢ
ID—Influence Distance of the i^{th} KE
avg_dist_of KE's_hits to KEᵢ—the average distance between the input vectors that i.fell within the ID of KEᵢ and KEᵢ

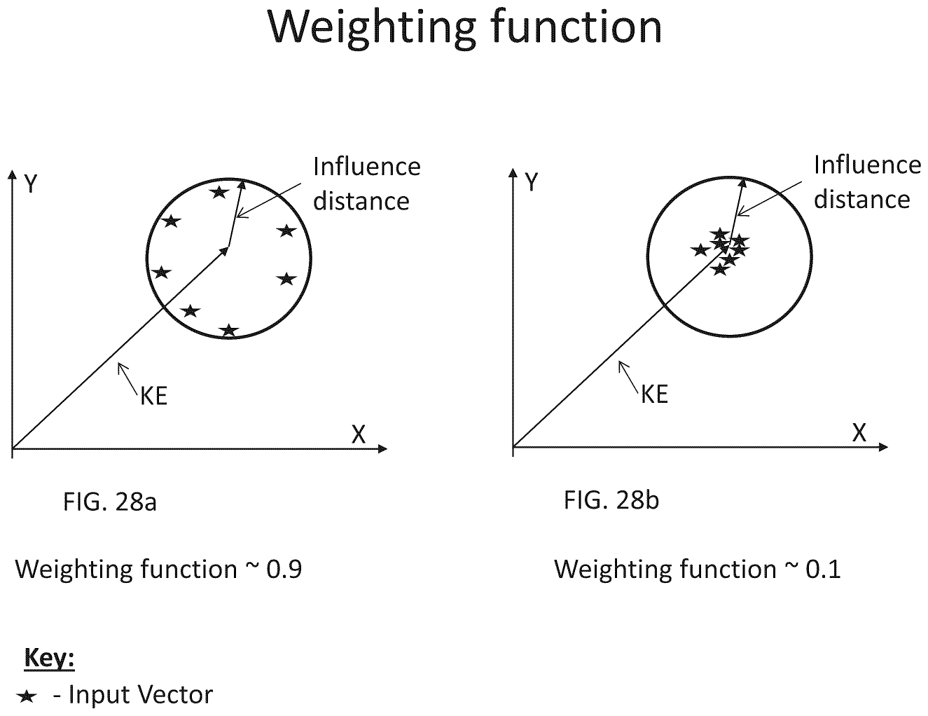

Referring to FIGS. 28a-b, the weight value is defined as a normalized average distance between a KE and the input vectors that are within the influence distance of that vector. FIGS. 28a-b illustrate two scenarios. FIG. 28a illustrates a first scenario wherein the input vectors reside close to the boundaries of the influence distance of a KE. In this case the input vectors are at a distance which is substantially similar to the influence distance of the KE. Normalizing the average distance by the size of the value of the influence distance results in a number close to 1, e.g., 0.9. FIG. 28b illustrates a second scenario wherein the input vectors reside close to the center of the KE and as such the average distance between each input vector and the KE is close to zero. Normalizing the average distance by the influence distance results in a number close to zero, e.g., 0.1. In general, the weight of a KE assumes values within [0-1.

Returning to FIGS. 27a-c, the process proceeds to operation 2718 where the quality (Q) of the KE is determined. In some implementations, the quality of a KE is defined by

Qᵢ=Hit Countᵢ/Ageᵢ Equ. 2
Where:
Qᵢ—Quality parameter of the i^{th} KE
Hit Countᵢ—Hit count of the i^{th} KE
Ageᵢ—Age of the i^{th} KE

While the flowchart indicates that the quality of the KE is calculated each time when the input vector is within the ID of an existing KE, in accordance with some other implementations, the quality of the KE is calculated on demand. For example, the demand for this value may exist only when the method determines which KE should be evicted, such as in operation 2734 which is described in greater detail below. In some implementations, when the number of hits in a specific KE, Hit-Countᵢ, is implemented as an integer number, to ensure that the number of hits does not overflow, if a KE has reached a predetermined threshold, e.g., a max hit count, rather than increasing the number of hits of this specific KE, the system may decrease all other hit counts so as to maintain the relative number of hits among the various KEs. In operation 2720, the step size by which a value of an ID is adjusted is determined for each ID. In some other implementations, the system utilizes a single step size for all of the KEs. When a global step size is used, it is determined by the percentage of overall percentage of hits and misses of all of the KEs. For example, a set percentage of the current ID size may be used to increase or decrease its size given the model miss rate. The process proceeds to operation 140 (see below).

Greater efficiency can be achieved by incorporating the use of early stopping during distance calculations as KEs are searched to find the nearest. Given a current nearest KE distance, as the distance to subsequent KEs is calculated, if the distance exceeds the nearest KE distance before the distance calculation is complete, it is abandoned as only the nearest KE is desired for evaluation. Knowing the order of KEs from closest to most distant from the current test vector is desirable during weighted average distance calculation to the KEs. Some implementations include all KEs being searched in which case no early stopping would be used. Some other implementations only include a subset of KEs to be searched. In this case, early stopping could be used to maintain the desired number of smallest distances to KEs.

However, if operation 2708 determines that the input vector does not fall within the influence distance of any existing KE, the input vector is used to instantiate a new KE (2730). Operation 2732 determines whether the number of KEs exceeded a predetermined threshold, e.g., MaxNum KEs. If the number of KEs does not exceed the predetermined threshold, the process proceeds to operation 2740 (see below).

If affirmative, execution proceeds to operation 2734 where a specific KE is selected and eliminated. In accordance with some implementations, the KE with the lowest quality (Q) is eliminated, where the quality of a KE is determined in operation 2718. In accordance with some other implementations, operation 2734 only considers KEs with an age greater than a predetermined threshold, e.g., Min_Req_Age, for elimination.

In operation 2740, a system wide miss rate is determined. In accordance with some implementations, the miss rate may be calculated for the most recent predetermined number of test (input) vectors.

Operation 2742 compares the miss rate to a predetermined threshold 1 such as the configured Lower Bound Miss Rate. If the miss rate is smaller than the threshold, the flow proceeds to operation 2744; else the flow proceeds to operation 2745 where the miss rate is compared against threshold 2 such as the configured Upper Bound Miss Rate. If the miss rate is higher than the threshold, the flow proceeds to operation 2746; else if the miss rate value falls between the two thresholds, the size of the ID is not altered and flow continues directly to operation 2750.

In operation 2744, the influence distance (ID) is reduced by the specified step size. Similarly, in operation 2746, the influence distance is increased by a specified step size. In accordance with some implementations, the operations employ a dynamic step size wherein the value of the step size is weighted by the difference between the miss rate and predetermined thresholds such as Upper Bound Miss Rate or Lower Bound Miss Rate. In accordance with some other implementations, when the ID size is modified, the hit and miss rates may be evaluated.

In accordance with some implementations, the system determines and maintains the distance of each test vector to the nearest KE, e.g., as part of its metadata. In accordance with some other implementations, when the system updates the value (size) of the ID (or IDs), the classification whether a test vector is a hit or a miss may be re-evaluated.

The anomaly of the input vector (A) is determined in operation 2750. In accordance with some implementations, the operation utilizes the system model that was implemented by the previous operations. The operation determines the anomaly value of the input average by calculating the average distance of the input vector to all existing KEs. In accordance with some implementations, the distance to each KE is weighted by the specific's KE's hit count. For example

aᵢ(KEᵢ)=Distance(KEᵢ→Input Vector)*Hit Count(KEᵢ)/Total Hit Count Equ. 3
Where:
aᵢ(KEᵢ)—anomaly component contributed by the i^{th} KE
Distance (KEᵢ→Input Vector)—distance between the input vector and the i^{th} KE
Hit Count (KEᵢ)—The hit count of the i^{th} KE
Total Hit Count—total hit count of all KEs
and

A(Input Vector)=Σᵢ₌₁^{Num of KEs}(aᵢ(KEᵢ) Equ. 4
Where:
A(input vector)—anomaly of the input vector
Num of KEs—total number of KEs in the model
aᵢ(KEᵢ)—anomaly component contributed by the i^{th} KE

In order to reduce computational complexity of the algorithm the calculation of the input vector anomaly may utilize only a subset of the KEs. For example, in accordance with some implementations, the anomaly is determined based on a subset of KEs until a predetermined percent of the total model hits is represented. In accordance with some other implementations, the anomaly is determined based on a subset of k Kes, e.g., KEs that are the closest to the input vector. In accordance with some implementations, the number of KEs to be considered is determined by the following process. The method may take fixed (pre-configured) KEs, e.g., 10 KEs. In accordance with some other implementations, the system may consider the KEs in order of distance to the test vector and will compute the total number of hits of these KE until the total reaches a predetermined percentage of hits (e.g., 25% of the overall system hits). Other methods are included in some implementations as well.

In some implementations and depending on the feature extraction process used, statistical measurements of individual vectors may be measured as another form of metadata. These statistical measurements of the vectors may include mean, standard deviation, etc. of the amplitude or any other measurements. When distances between KEs and test vectors are measured, these statistical values can be considered in the distance calculation. In some implementations, these values may be appended onto the existing vectors of the KEs and current test vector. These statistical values may be weighted for greater or less significance than the vector distance or they can be normalized to give equal weight to each component.

Aᵢ(KEᵢ)=(Distance(KEᵢ→Input Vector)+w*Distance(KEᵢ Stats→Input Vector Stats))*Hit Count(KEᵢ)/Total Hit Count Equ. 3.1
Where:
aᵢ(KEᵢ)—anomaly component contributed by the i^{th} KE
Distance (KEᵢ→Input Vector)—distance between the input vector and the i^{th} KE
w*Distance(KEᵢStats→Input Vector Stats)—weighted distance between the input vector statistical elements and the i^{th} KE statistical elements
Hit Count (KEᵢ)—The hit count of the i^{th} KE
Total Hit Count—total hit count of all KEs

In operation 2754, the anomaly of the input vector is compared against a predetermined threshold. If the anomaly of the input vector is determined to be smaller than a predetermined threshold, the input vector is deemed to be a “normal” input vector (2756). Otherwise, the input vector is deemed to be an “anomalous” input vector in operation 2758.

The process ends in operation 2760 in some implementations. In accordance with some other implementations (not shown for sake of simplicity), the process loops back to operation 2702 where a new input vector is processed.

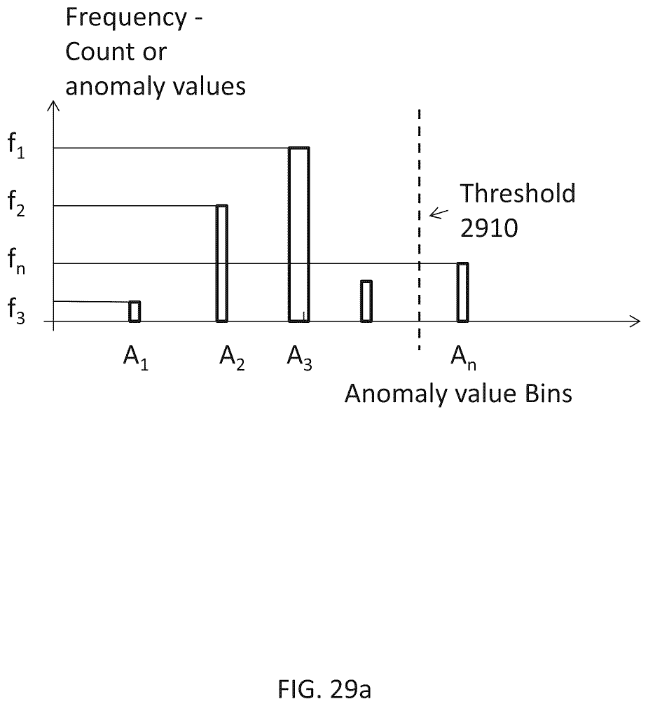

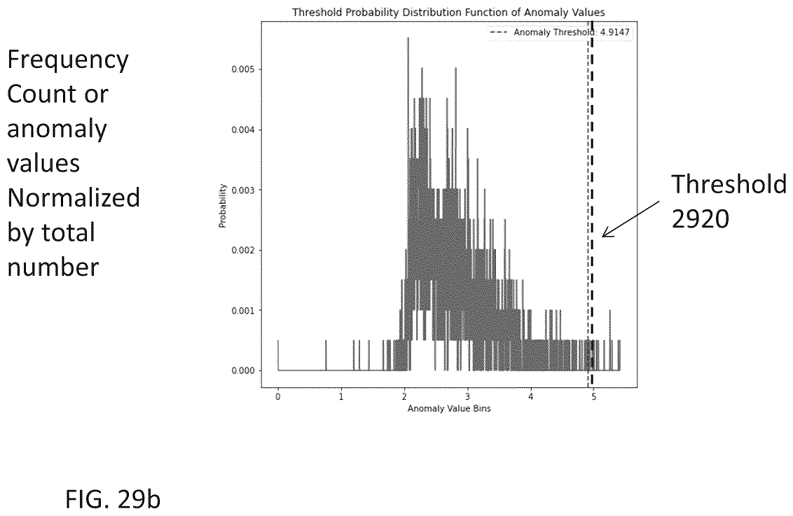

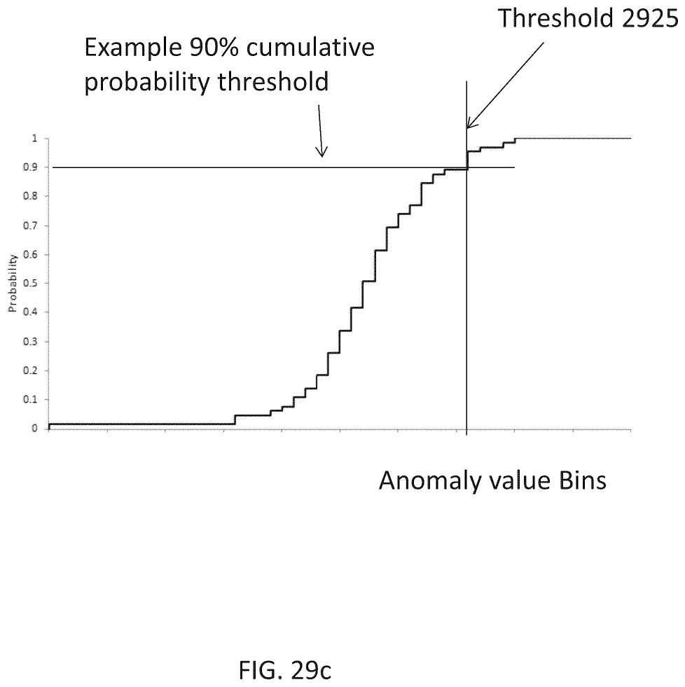

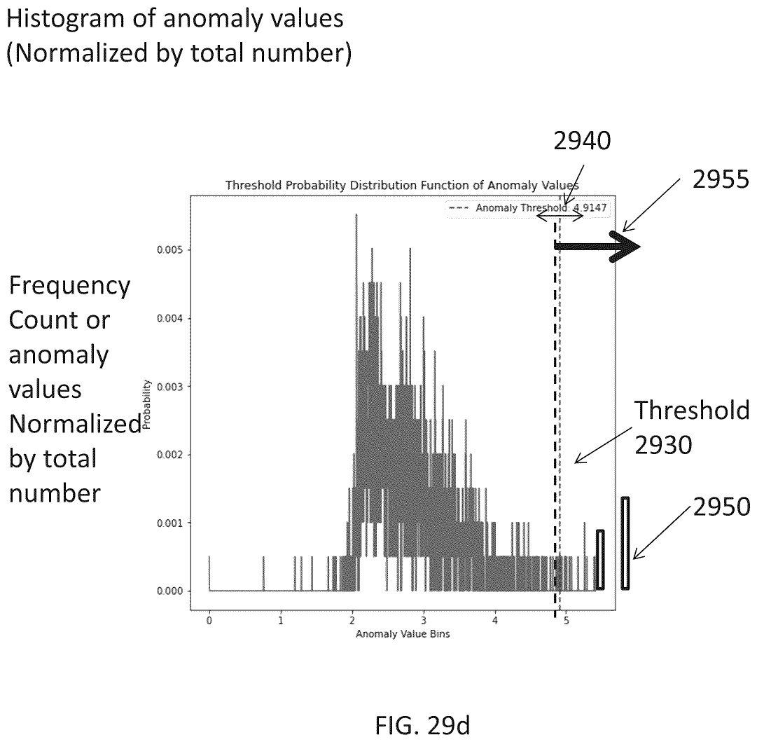

In some implementations, the system determines the frequency of the occurrences of various anomaly values associated with the input vectors. For example, the system may determine bins for various anomaly values, e.g., bins for values such as [0.0-0.1), [0.1-0.1), [0.2-0.3), etc., and count how many anomaly values of the input test vectors falls within the specified range. FIG. 29a illustrates an example of a histogram of occurrences of various anomaly values wherein anomaly A₁ occurs with frequency f₁, anomaly A₂ occurs with frequency f₂, anomaly A₃ occurs with frequency f₃ . . . , and anomaly Aₙ occurs with frequency fₙ.

Keeping with the previous example, when the anomaly of a specific input vector falls within the first range of [0.0-0.1) the A₁ count is incremented; when the anomaly of a specific vector falls within the second range of [0.1-0.1) the A₂ count is incremented; when the anomaly of a specific vector falls within the third range of [0.2-0.3) the A₃ count is incremented; etc. As explained below with greater detail, a threshold 2910 is used to determine whether an anomaly behavior is detected by the system.

FIG. 29b provides yet another view of the anomaly distribution, where the frequency values of the histogram of FIG. 29a are normalized resulting in a probability distribution function. In accordance with some implementations, the method uses this distribution function to determine an anomaly threshold. In accordance with one specific example, the method steps through the various probability values from right to left accumulating probability until the given cumulative probability of an anomaly is reached. Then the anomaly threshold is the last anomaly value whose probability was accumulated. For example, the method may accumulate up to e.g., 3% of the anomaly values and when this value is reached determine the specific anomaly value as a threshold 2920.

FIG. 29c provides yet another example method for determining the threshold for identifying an anomaly. The figure describes a cumulative distribution function based on the distribution function shown in FIG. 29a or 29b. In this example, events that occurred less than, e.g., 10% of the time are assumed to be outliers and as such are assumed to be an anomaly. The value of the threshold is defined by the intersection between a user defined cumulative distribution function threshold and the cumulative distribution function. Specifically, the probability distribution function can be iteratively stepped through from greatest to least anomaly value. At each step, the amount of probability associated with each bin is summed. When the accumulated probability exceeds the given probability of an anomaly, the anomaly value associated with the final step is used to set the anomaly threshold. The anomaly threshold can be set at or above this anomaly value (or anomaly bin).

Referring to FIG. 29d, the threshold 2930 is updated periodically, e.g., every 100, 1000, 10,000, etc. input vectors, based on the variation in the behavior of the system and more specifically based on the dynamic distribution of the anomaly values. The arrow 2940 illustrates the dynamic changes in the value of the threshold based on the dynamic changes of the anomaly values of the input vectors. Small changes like this are expected and do not result in anomaly declaration.

However when the system experiences abnormal behavior, the distribution function of the anomaly values changes, e.g., values in some anomaly values are detected, e.g., values 2950. These new values result in a big change in the value of the threshold which is calculated in the next period. This large change triggers anomaly detection and alerting of a technician or triggering an automated corrective action. A data scientist may use this information to identify an anomaly input vector or a collection of anomaly inputs associated with a KE, for example, based on a known probability of anomaly. For example, a data scientist may identify input vectors associated with A₃ which falls below a predetermined threshold as rare occurrences which represent an anomaly.

In another example scenario, a data scientist may tag a KE with rare hit rate of input vectors as a normal KE based on his understanding of the model and the input data. For example, the sound and vibration of a starting engine may be rare but because they do not represent a malfunctioning engine, a data scientist may tag a KE associated with input from sensors resulting from starting an engine as normal (despite the fact that they are less frequent than the sound of running engine.

In accordance with some other implementations, KEs with the largest anomaly values are assumed to represent an anomaly. Without limitation, other empirical and statistical methods can be used to automatically identify outliers such as an anomaly. For example, the method may utilize the Z-Score method to identify outliers as an anomaly.

Z-Score=(A(input vector)−μ)/σ Equ. 5
μ—mean value of all input vectors within a predetermined period
σ—standard deviation of the anomaly values within a predetermined period

The system may then utilize the Z-score to automatically identify anomaly events based on the z-score of a specific input vector. In general Z-score is a measure of the number of standard deviations by which the value of a raw score (i.e., an observed value or data point) is above or below the mean value of what is being observed or measured. In accordance with some implementations, the method approximates the probability distribution function of the anomaly values by deriving the distribution function empirically. As anomaly values are calculated for test vectors, these anomaly values are used to calculate the associated probability distribution function by placing the various values in bins according to their values and counting the number of vectors associated with each anomaly range bin.

It should be noted that the Z-test is brought as a non-limiting example and other statistical tests such as the Kolmogorov-Smirnov test, T-Test, etc. are contemplated as within the scope of this disclosure.

In addition to classifying individual vectors as anomalous, anomaly values (weighted average distance values) may be collected within windows of time, the distribution of which describes the behavior of data within the time windows. Distributions of anomaly values collected within windows of time may be compared to evaluate change in provided vectors within the given time frame. In some implementations, to measure overall system drift, the model could be provided data vectors before being frozen (no more KE generation). The distributions within each subsequent time window could be evaluated to detect sufficient drift in the data. In some other implementations, distributions of anomaly values within subsequent windows could be evaluated to detect if the data is drifting (changing) faster than some threshold (since the model will continue to adjust as new data is presented).

The distributions may be modeled using kernel density estimation.

Distributions of anomaly values (weighted average distance values) collected within time windows may be compared many ways to describe how the system is changing. Statistical measurements of these distributions may be calculated and compared to describe how the distributions change in time. Further non-limiting examples include calculating the mean, variance (standard deviation), skewness and kurtosis of each distribution. These statistical measurements can be evaluated between time windows. Some implementations include calculating the higher order statistics of the distribution from the current window of time using the mean measured from the previous window of time (centering moments around the previous mean) to better characterize the change of the distribution. For some implementations where the knowledge map is frozen, the mean from the distribution at the time of freezing can be used while calculating the higher order statistics.

The distributions modeled as vectors (where each dimension is a bucket) may be compared directly using examples such as Kolmogorov-Smirnov test, T-Test, Chi-squared test. The distribution vectors from different windows of time may be compared using a second round of distance calculations, creating a second order knowledge map. Such a knowledge map may only contain the previous distribution vector in which case the previous vector would always become the new knowledge element, or it may contain multiple distribution vectors and therefore potentially multiple knowledge elements. Knowledge element(s) influence field distance in this second order knowledge map define the distance threshold of a distribution vector used as the system anomaly determination. If the currently evaluated distribution vector ‘hits’ a knowledge element, then the system is evaluated to behave normally, otherwise, missing is evaluated to be anomalous behavior. The partition influence distance likely needs to be a static parameter in some implementations.

In accordance with some other implementations, this ATAD (Adaptive Threshold Anomaly Detection) may be accomplished with minimal memory requirements. A counter is used to track the number of anomaly values calculated to provide the probability resolution for each value. While under the resolution required by the probability of an anomaly, only the largest anomaly value need be stored (and the probability of an anomaly can be set past this value or a prediction can wait until the proper probability resolution). After the number of anomaly values affords the necessary probability resolution, several options are available depending on memory constraints. For a minimalist approach, only the single largest anomaly value need be held for the last n (assuming n is the number of anomaly values needed for the probability resolution) anomaly values (the value needs to age out so others must be held in reserve for when this happens). The smaller window of time of the evaluated anomaly values makes this an adaptive method for the anomaly threshold (any larger anomaly value will instantly shift out to whatever this value is) For a less dynamic anomaly threshold, m largest anomaly values are held at a time and the threshold is set by accumulating probability as described above (these values may also age out).

For example, assuming a predetermined and configured probability of an anomaly is 0.02: Track the current largest 20 anomaly values out of the last 1000 samples and the previous largest 20 anomaly values for the previous 1000 samples. Then age out (remove) the 20 largest anomaly values of the previous 1000 samples, and start accumulating the top 20 of the next 1000 samples. This allows there to always be 20-40 largest samples for the ATAD thresholding.

The z-score and ATAD methods can be used together to provide additional information about a given anomaly value in relation to the history of anomaly values. For arbitrarily small probability of an anomaly, quartile statistics can be used, and the right tail of the anomaly value distribution can be modeled (e.g., by extrapolation). Other statistical methods, while not described for sake of simplicity, are contemplated as well.

It should be noted that anomaly values will change as new vectors are introduced (both because new KEs may be created and because the hit counts may be changing). Therefore, some implementations may recalculate and update the anomaly values considered in the probability distribution after each new input vector is introduced. Some other implementations trade-off accuracy with computation efficiency and recalculate and update the anomaly values only periodically.

In case the new test vector creates a KE, in accordance with another aspect, the classification of an anomaly can initiate specific behavior to describe the distribution of anomaly values. This classification can help determine if anomaly values are randomly distributed among “normal” data or if there is some baseline shift in the data. Such shift may be useful for detecting deterioration in system's normal operation, e.g., provide an indicator that system requires maintenance.

The method described above can identify discrete anomaly outliers (such as events caused by abrupt change; e.g., system breakage) as well as unacceptable drift anomaly (such as a slow change in operational parameters, e.g., a slow wear and tear).

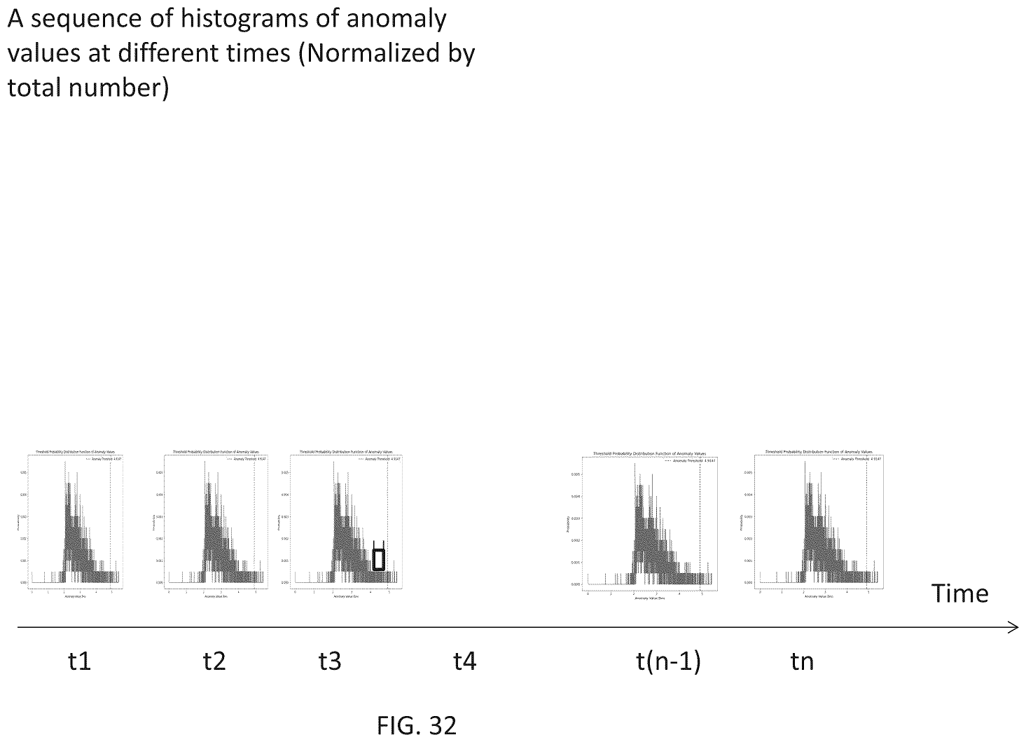

Referring to FIG. 32, a sequence, at different times, of histograms of anomaly values is described. In order to determine a discrete anomaly outlier, the method compares the histogram at a given time, e.g., t₁ to the previous histogram at time tᵢ₋₁. Using the illustrated sequence of histograms in the example of FIG. 32 and statistically comparing the histograms at times t₁ and t₂, e.g., using T-test, results in a conclusion that the histograms are substantially similar. As a result the method does not determine an anomaly condition. Similarly, comparing the histograms at times tₙ and t₍ₙ₋₁₎, e.g., using T-test, results in a conclusion that the histograms are substantially similar and therefore an anomaly is not detected.

However, comparing the histograms at times t₃ and t₂, e.g., using T-test, results in a conclusion that the histograms are different enough and therefore the method determines that a discrete anomaly is detected.

To detect a drift anomaly, the method compares anomaly value histograms separated by k time periods. Using the illustrated sequence of histograms in the example of FIG. 32 and statistically comparing the histograms at times t₁ and t₍ₙ₋₁₎, e.g., using T-test, results in a conclusion that the histograms are substantially different. As a result the method determines a drift anomaly condition. Similarly, comparing the histograms at times t₂ and tₙ, e.g., using T-test, results in a conclusion that the histograms are substantially different and therefore a drift anomaly is detected.

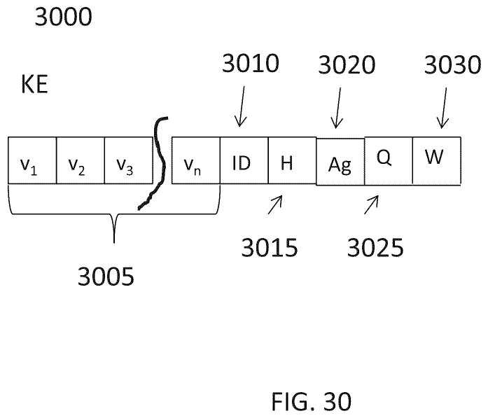

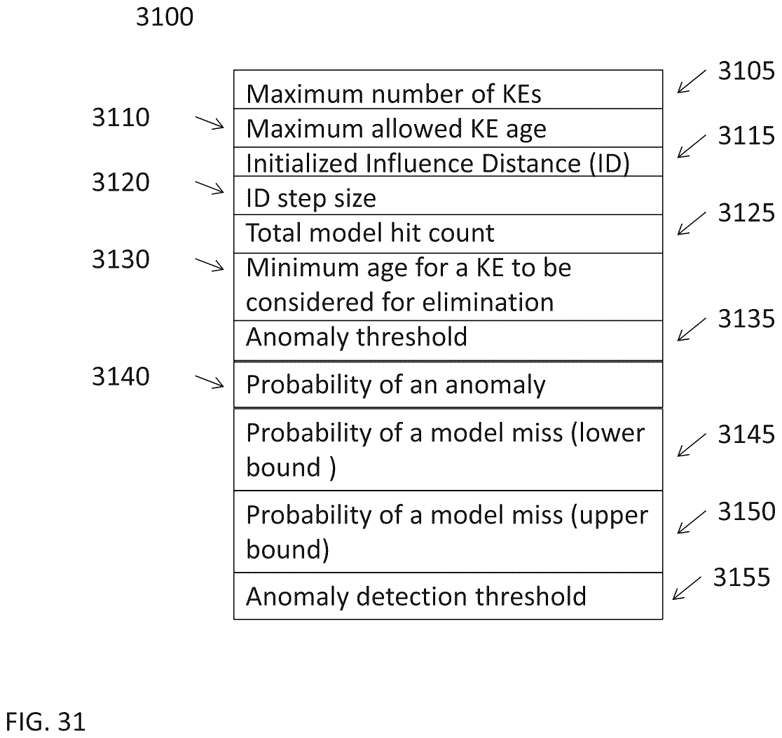

FIG. 30 is an example illustration of a knowledge element (KE) 3000. The v₁, v₂, v₃, . . . vₙ values (3005) represent the location of the KE vector in an n dimensional space. The remaining values represent, without limitation, values of various metadata elements such as the influence distance (3010), hit rate counter (3015), the age of the KE (3020), the quality Q (3025) of the KE, and the weighting function value (3030). The figure provides a simplified illustration of a KE data structure. Other data structures may be used with additional (or less) data elements in the metadata.

While FIG. 30 illustrates an example metadata structure of a KE, a similar data structure may be used to configure known specific data sets as being either ‘normal’ or an ‘anomaly’.

31 is an illustration of various parameters, e.g., thresholds, determined values, etc. 3100 and system-derived values used by the system. Some of these values may be stored as metadata associated with a KE. This figure provides a simplified list without limitations. Other parameters may be used and/or derived by the system.

Maximum number of KEs (3105) is a parameter that ensures that the number of KEs is kept low to ensure low computational requirements for the anomaly detection engine.

Maximum allowed KE age (3110) is a parameter that ensures that the counter indicative of the age of any KE does not overflow.

Initialized Influence Distance (ID) (3115) is a parameter that sets an initial value for the size of an ID.

ID step size (3120) is a parameter that sets the initial step size for dynamically modifying the size of IDs. In some implementations, the size of the step may be dynamically changed by the anomaly detection engine.

Total model hit count (3125) is a counter that counts the total number of input vectors that fell within an ID of any KE.

Minimum age for a KE to be considered for elimination (3130) is a parameter that ensures that KEs do not get eliminated prematurely.

Anomaly threshold (3135) is a parameter that is used to determine which input vectors should be considered anomalies.

Probability of an anomaly (3140) is a parameter that is used to determine the threshold used in the process of determining which input vectors should be considered anomalies.

Probabilities of a model miss (lower and upper bounds) (3145 and 3150) are parameters that may be used in some implementations to determine the step size for adjusting the ID size value, and in some other implementations may be used for determining the actual value of the ID.

Anomaly detection threshold (3155) is a configurable value that is used along with the tests described above to determine anomalies. For example, the number can serve along with the Z-Test, T-Test, K-S Test to identify the new anomaly probability distribution diverged from previous anomaly distribution and trigger a notification that an anomaly has been detected. In accordance with some implementations, the threshold provides the amount that the threshold, e.g., threshold 2940 needs to change in order for the engine to determine that it detected an anomaly.

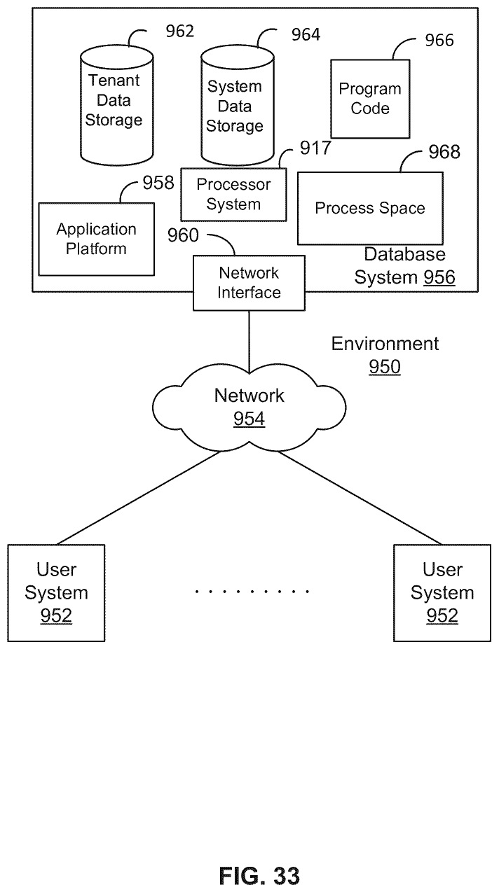

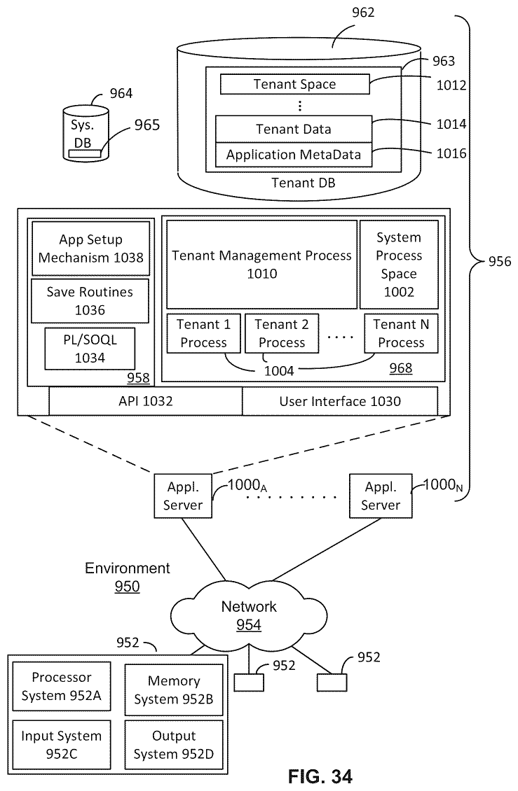

FIG. 33 shows a block diagram of an environment 950 wherein anomaly detection may be performed, in accordance with some implementations. Environment 950 includes an on-demand database service. User system 952 may be any machine or system that is used by a user to access a database service. For example, any of user systems 952 can be a handheld computing system, a mobile phone, a laptop computer, a workstation, and/or a network of computing systems. As illustrated in FIGS. 33 and 34, user systems 952 might interact via a network 954 with the on-demand database service.

An on-demand database service, such as a system 956, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 956” and “system 956” will be used interchangeably herein. A database image may include one or more database objects. A relational database management system (RDBMS) or the equivalent may execute storage and retrieval of information against the database object(s). In some other implementations, a non-RDBMS can be used to provide storage and retrieval. Application platform 958 may be a framework that allows the applications of system 956 to run, such as the hardware and/or software, e.g., the operating system. In some implementations, on-demand database service 956 may include an application platform 958 that enables creation, managing and executing one or more applications developed by the provider of the on-demand database service, users accessing the on-demand database service via user systems 952, or third party application developers accessing the on-demand database service via user systems 952.

Possible arrangements for elements of system 956 are shown in FIGS. 33 and 34. For instance, system 956 can include a network interface 960, application platform 958, tenant data storage 962 for tenant data 963, system data storage 964 for system data 965 accessible to system 956 and possibly multiple tenants, program code 966 for implementing various functions of system 956, and a process memory space 968 for executing MTS system processes and tenant-specific processes, such as running applications as part of an application hosting service. Additional processes that may execute on system 956 include database indexing processes.

The users of user systems 952 may differ in their respective capacities, and the capacity of a particular user system 952 might be entirely determined by permissions (permission levels) for the current user. Thus, different users may have different capabilities with regard to accessing and modifying application and database information, depending on a user's security or permission level.

Network 954 is any network or combination of networks of devices that communicate with one another. For example, network 954 can be any one or any combination of a LAN (local area network), WAN (wide area network), telephone network, wireless network, optical network, point-to-point network, star network, token ring network, hub network, or other appropriate configuration. As the most common type of computer network in current use is a TCP/IP (Transfer Control Protocol and Internet Protocol) network (e.g., the Internet), that network will be used in many of the examples herein. However, it should be understood that the networks used in some implementations are not so limited, although TCP/IP is a frequently implemented protocol.

User systems 952 might communicate with system 956 using TCP/IP and, at a higher network level, use other common Internet protocols to communicate, such as HTTP, FTP, AFS, WAP, etc. In an example where HTTP is used, user system 952 might include an HTTP client commonly referred to as a “browser” for sending and receiving HTTP messages to and from an HTTP server at system 956. Such an HTTP server might be implemented as the sole network interface between system 956 and network 954, but other techniques might be used as well or instead. In some implementations, the interface between system 956 and network 954 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In some implementations, system 956 includes application servers configured to implement and execute anomaly detection software applications as well as provide related data, code, forms, webpages and other information to and from user systems 952 and to store to, and retrieve from, a database system related data, objects, and webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. For example, system 956 may provide tenant access to multiple hosted (standard and custom) applications. User (or third party developer) applications may be supported by the application platform 958, which manages creation, storage of the applications into one or more database objects and executing of the applications in a virtual machine in the process space of the system 956.

Each user system 952 could include a desktop personal computer, workstation, laptop, PDA, cell phone, or any wireless access protocol (WAP) enabled device or any other computing system capable of interfacing directly or indirectly to the Internet or other network connection. User system 952 typically runs an HTTP client, e.g., a browsing program, such as Microsoft's Internet Explorer® browser, Mozilla's Firefox® browser, Opera's browser, or a WAP-enabled browser in the case of a cell phone, PDA or other wireless device, or the like, allowing a user (e.g., subscriber of the multi-tenant database system) of user system 952 to access, process and view information, pages and applications available to it from system 956 over network 954.

In accordance with some other implementations, user system 952 may run a dedicated program to access system 956.

Each user system 952 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 956 or other systems or servers. For example, the user interface device can be used to access data and applications hosted by system 956, and to perform searches on stored data, and otherwise allow a user to interact with various GUI pages that may be presented to a user. As discussed above, some implementations are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

In accordance with some other implementations, user system 952 includes a microphone that enables the user to interact with system 956 using speech and natural language recognition (NLR) or natural language processing (NLP).

According to some implementations, each user system 952 and all of its components are operator configurable using applications, such as a browser, including computer code run using a central processing unit such as an Intel Pentium® processor or the like. Similarly, system 956 (and additional instances of an MTS, where more than one is present) and all of their components might be operator configurable using application(s) including computer code to run using a central processing unit such as processor system 957, which may include an Intel Pentium® processor or the like, and/or multiple processor units.

A computer program product implementation includes a machine-readable storage medium (media) having instructions stored thereon/in which can be used to program a computer to perform any of the processes of the implementations described herein. Computer code for operating and configuring system 956 to intercommunicate and to process webpages, applications and other data and media content as described herein are preferably downloaded and stored on a hard disk, but the entire program code, or portions thereof, may also be stored in any other volatile or non-volatile memory medium or device, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory Ics), or any type of media or device suitable for storing instructions and/or data. Additionally, the entire program code, or portions thereof, may be transmitted and downloaded from a software source over a transmission medium, e.g., over the Internet, or from another server, or transmitted over any other conventional network connection (e.g., extranet, VPN, LAN, etc.) using any communication medium and protocols (e.g., TCP/IP, HTTP, HTTPS, Ethernet, etc.). It will also be appreciated that computer code for carrying out disclosed operations can be implemented in any programming language that can be executed on a client system and/or server or server system such as, for example, C, C++, Python, R, HTML, any other markup language, Java™, JavaScript®, ActiveX®, any other scripting language, such as VBScript, and many other programming languages as are well known may be used. (Java™ is a trademark of Sun Microsystems®, Inc.).

According to some implementations, each system 956 is configured to provide webpages, forms, applications, data and media content to user (client) systems 952 to support the access by user systems 952 as tenants of system 956. As such, system 956 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include logically and/or physically connected servers distributed locally or across one or more geographic locations. Additionally, the term “server” is meant to include a computing system, including processing hardware and process space(s), and an associated storage system and database application (e.g., OODBMS or RDBMS) as is well known in the art.

It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 34 also shows a block diagram of environment 950 further illustrating system 956 and various interconnections, in accordance with some implementations. FIG. 34 shows that user system 952 may include processor system 952A, memory system 952B, input system 952C, and output system 952D. FIG. 34 shows network 954 and system 956. FIG. 34 also shows that system 956 may include tenant data storage 962, tenant data 963, system data storage 964, system data 965, User Interface (UI) 1030, Application Program Interface (API) 1032, a query language such as SQL or PL/SOQL 1034, save routines 1036, application setup mechanism 1038, applications servers 1000A-1000N, system process space 1002, tenant process spaces 1004, tenant management process space 1010, tenant storage area 1012, tenant data 1014, and application metadata 1016. In other implementations, environment 950 may not have the same elements as those listed above and/or may have other elements instead of, or in addition to, those listed above.

User system 952, network 954, system 956, tenant data storage 962, and system data storage 964 were discussed above in FIG. 33. Regarding user system 952, processor system 952A may be any combination of processors. Memory system 952B may be any combination of one or more memory devices, short term, and/or long term memory. Input system 952C may be any combination of input devices, such as keyboards, mice, trackballs, scanners, microphone, cameras, and/or interfaces to networks. Output system 952D may be any combination of output devices, such as monitors, printers, and/or interfaces to networks. As shown by FIG. 34, system 956 may include a network interface 960 (of FIG. 33) implemented as a set of HTTP application servers 1000, an application platform 958, tenant data storage 962, and system data storage 964. Also shown is system process space 1002, including individual tenant process spaces 1004 and a tenant management process space 1010. Each application server 1000 may be configured to tenant data storage 962 and the tenant data 963 therein, and system data storage 964 and the system data 965 therein to serve requests of user systems 952. The tenant data 963 might be divided into individual tenant storage areas 1012, which can be either a physical arrangement and/or a logical arrangement of data. Within each tenant storage area 1012, tenant data 1014 and application metadata 1016 might be similarly allocated for each user. For example, a copy of a user's most recently used (MRU) items might be stored to tenant data 1014. Similarly, a copy of MRU items for an entire organization that is a tenant might be stored to tenant storage area 1012. A UT 1030 provides a user interface and an API 1032 provides an application programmer interface to system 956 resident processes to users and/or developers at user systems 952. The tenant data and the system data may be stored in various databases, such as Oracle™ databases.

Application platform 958 includes an application setup mechanism 1038 that supports application developers' creation and management of applications, which may be saved as metadata into tenant data storage 962 by save routines 1036 for execution by subscribers as tenant process spaces 1004 managed by tenant management process 1010 for example. Invocations to such applications may be coded using a query language such as SQL or PL/SOQL 1034 that provides a programming language style interface extension to API 1032. Invocations to applications may be detected by system processes, which manage retrieving application metadata 1016 for the subscriber making the invocation and executing the metadata as an application in a virtual machine.

Each application server 1000 may be communicably coupled to database systems, e.g., having access to system data 965 and tenant data 963, via a different network connection. For example, one application server 1000 might be coupled via the network 954 (e.g., the Internet), another application server 1000 might be coupled via a direct network link, and another application server 1000 might be coupled by yet a different network connection. Transfer Control Protocol and Internet Protocol (TCP/IP) are typical protocols for communicating between application servers 1000 and the database system. However, other transport protocols may be used to optimize the system depending on the network interconnect used.

In some implementations, each application server 1000 is configured to handle requests for any user associated with any organization that is a tenant. Because it is desirable to be able to add and remove application servers from the server pool at any time for any reason, there is preferably no server affinity for a user and/or organization to a specific application server 1000. In some implementations, therefore, an interface system implementing a load balancing function (e.g., an F5 Big-IP load balancer) is communicably coupled between the application servers 1000 and the user systems 952 to distribute requests to the application servers 1000. In some implementations, the load balancer uses a least connections algorithm to route user requests to the application servers 1000. Other examples of load balancing algorithms, such as round robin and observed response time, also can be used. For example, in certain implementations, three consecutive requests from the same user could hit three different application servers 1000, and three requests from different users could hit the same application server 1000. In this manner, system 956 is multi-tenant, wherein system 956 handles storage of, and access to, different objects, data and applications across disparate users and organizations.

In certain implementations, user systems 952 (which may be client machines/systems) communicate with application servers 1000 to request and update system-level and tenant-level data from system 956 that may require sending one or more queries to tenant data storage 962 and/or system data storage 964. System 956 (e.g., an application server 1000 in system 956) automatically generates one or more SQL statements (e.g., SQL queries) that are designed to access the desired information. System data storage 964 may generate query plans to access the requested data from the database.

In another aspect of the disclosure, an anomaly detection engine may be implemented as a preprocessing and filtering element. For example, an anomaly detection engine may be deployed close to a sensor at the edge of the network such as in areas where network resources are limited or expensive. Rather than sending all of the collected raw data from the sensor to a central data processing system such as a central data center, a system in accordance with this disclosure utilizes an anomaly detection engine to categorize events based on their level of being “normal” or “not normal”. The system then can be programmed to send to the data center and/or to the cloud only events that correspond to a center level of abnormality. Since it is assumed that under normal conditions the majority of the events are going to be “normal”, the edge device, with its associate anomaly detection engine, would refrain from sending data to the data center. However, when the anomaly detection engine would identify abnormal operation or abnormal data coming out of the sensor system, the edge device would format a message and send it to the central data processing system for further processing and handling.

A message from the edge device may include the following elements: id of the edge device, the feature vector that caused the determination of the abnormal condition, the raw data from which the feature vector was constructed, a label associated with the class of abnormality that the anomaly detection engine detected, and/or a number quantifying the level of the abnormality.

The central data processing system may process the received data and compare the level of abnormality detected by the edge anomaly detection engine with the central data processing system's evaluation. When the central data processing system determines that the reported anomaly detection engine matches the central data processing system's level of anomaly calculations, the process continues without any change. However, when the anomaly levels are different, the central data processing system may request the edge system to send additional information about the new normal in order for the central data processing system to update the central data model.

The central data processing system may perform supervised classification of the data tagged anomalous by the edge system. If there exists a set of vectors with associated classification labels, the edge device can detect anomalous vectors, send them to the central data processing system, and the central data processing system can determine if the identified data is likely to be classified into one of the known classes. In some implementations, labels for vectors of interest may be sent to edge systems to perform certain classification on the edge systems, while in some other implementations, the edge system will only send data to a central data processing system which determines the validity of an anomaly declaration and potentially a classification task.

In accordance with another aspect of the disclosure, whenever the anomaly detection engine in the edge device determines that the knowledge element associated with normal input has changed (e.g., the centroid moved by more than a predetermined threshold), the edge device formats a message to notify and update the central data processing system about the new definition of “normal” state.

These and other aspects of the disclosure may be implemented by various types and combinations of hardware, software, firmware, etc. For example, some features of the disclosure may be implemented, at least in part, by computer program product that include program instructions, state information, etc., for performing various operations described herein. Examples of program instructions include both machine code, such as produced by a compiler, and files containing higher-level code that may be executed by the computer using an interpreter. Examples of computer program product include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

While one or more implementations and techniques are described with reference to a system having an application server providing a front end for an on-demand database service capable of supporting multiple tenants, the one or more implementations and techniques are not limited to multi-tenant databases nor deployment on application servers. Implementations may be practiced using other database architectures, i.e., ORACLE®, DB2® by IBM and the like without departing from the scope of the implementations claimed.

Programmable logic devices (PLDs) are a type of digital integrated circuit that can be programmed to perform specified logic functions. One type of PLD, the field programmable gate array (FPGA), typically includes an array of configurable logic blocks (CLBS) surrounded by a ring of programmable input/output blocks (IOBs). Some FPGAs also include additional logic blocks with special purposes (Digital Signal Processing (DSP) blocks, Random Access Memory (RAM) blocks, Phase Lock Loops (PLL), and so forth). FPGA logic blocks typically include programmable logic elements such as lookup tables (LUTs), flip flops, memory elements, multiplexers, and so forth. The LUTs are typically implemented as RAM arrays in which values are stored during configuration (i.e., programming) of the FPGA. The flip-flops, multiplexers, and other components may also be programmed by writing configuration data to configuration memory cells included in the logic block. For example, the configuration data bits can enable or disable elements, alter the aspect ratios of memory arrays, select latch or flip-flop functionality for a memory element, and so forth. The configuration data bits can also select interconnection between the logic elements in various ways within a logic block by programmably selecting multiplexers inserted in the interconnect paths within CLB and between CLBs and IOBs.

While a number of aspects and implementations have been disclosed herein, those of skill in the art will recognize certain modifications, permutations, additions and sub-combinations thereof. It is therefore intended that the scope of this disclosure includes all such modifications, permutations, additions and sub-combinations. For example, the use of virtual knowledge elements in connection with physical engines can be implemented in other programmable logic circuits and in application specific integrated circuits (ASICs). An additional example would be where external memories (host based or local to the pattern recognition machine) are used to supplement the FPGA or ASIC “on-chip” memory to provide for larger numbers of knowledge elements. It is therefore not intended that the disclosure be limited except as indicated by the appended claims.

The disclosure is therefore not limited with respect to the network location where the operations are performed (e.g., cloud-based computing, edge computing, local computing, or any combination thereof). Nor is the disclosure limited to specific computing devices or computing techniques configured to perform the anomaly detection techniques described herein.

What is claimed is:

1. An anomaly detection system comprising:
a memory; and
one or more processors configured to cause:
obtaining, in association with a learning process, a plurality of input vectors,
iteratively processing the input vectors to compute a knowledge map,
iteratively processing the input vectors to determine metadata associated with one or more knowledge elements,
determining an anomaly value based on the knowledge map and the metadata, and
raising an alert that an anomaly was detected if the anomaly value traverses a threshold.

2. The system of claim 1, the one or more processors further configured to cause:
detecting at least one of a discrete anomaly outlier or a drift anomaly outlier.

3. The system of claim 1, the one or more processors further configured to cause:
identifying an anomaly event based on a statistical measure of a number of the input vectors within a designated timeframe corresponding to the anomaly value traversing the threshold.

4. The system of claim 1, the one or more processors further configured to cause:
applying the threshold to one or more of: a number of input vectors determined to be abnormal, or a speed by which a statistical measure of the number of abnormal vectors changes within a designated timeframe.

5. The system of claim 1, wherein the learning process includes one or more of: a continuous learning process or a periodic learning process.

6. The system of claim 1, wherein the threshold is dynamically adjustable.

7. The system of claim 1, wherein the knowledge map includes one or more of: a quality of the one or more knowledge elements, a model miss rate, a number of the one or more knowledge elements, a model hit count, one or more weights associated with the one or more knowledge elements, or an age of the one or more knowledge elements.

8. A system comprising:
an anomaly detection engine co-located with a sensor system at an edge of a network and configured to communicate with a data processing system, the anomaly detection engine configured to:
determine an anomaly of an input vector,
classify, based on the anomaly of the input vector, measured data associated with the sensor system, and
cause a message to be sent from an edge device at the edge of the network to the data processing system based on the classification.

9. The system of claim 8, wherein the anomaly detection engine is configured to cause the message to be sent from the edge device to the data processing system when a level of the anomaly of the input vector traverses a threshold.

10. The system of claim 8, wherein the data processing system is located at one of: a data center, the edge of the network, or both the data center and the edge of the network in a hybrid configuration.

11. The system of claim 8, wherein the anomaly detection engine is further configured to cause messages to not be sent from the edge device to the data processing system when a level of the anomaly of the input vector does not traverse a threshold.

12. A system comprising:
a data processing system configured to communicate with an anomaly detection engine co-located with a sensor system at an edge of a network, the data processing system configured to:
determine that an event designated by the anomaly detection engine as an anomaly is not an anomaly, and
send a message to an edge device at the edge of the network, the message indicating that the event should not be designated as the anomaly, the message configured to cause the anomaly detection engine to create a knowledge element indicating that the event is not an anomaly.

13. The system of claim 12, wherein the message is configured to prevent the anomaly detection engine from designating a future event as an anomaly based on a similarity between or among input vectors.

14. The system of claim 13, wherein the similarity between or among input vectors is determined by the input vectors being within a same knowledge element.

15. The system of claim 12, wherein the message is configured to prevent the anomaly detection engine from reporting detection of an anomaly to the data processing system based on a similarity between or among input vectors.

16. A non-transitory computer-readable medium storing computer-readable program code executable by one or more processors, the program code comprising instructions configured to cause:
obtaining, in association with a learning process, a plurality of input vectors;
iteratively processing the input vectors to compute a knowledge map;
iteratively processing the input vectors to determine metadata associated with one or more knowledge elements;
determining an anomaly value based on the knowledge map and the metadata; and
raising an alert that an anomaly was detected if the anomaly value traverses a threshold.

17. The non-transitory computer-readable medium of claim 16, the instructions further configured to cause:
detecting at least one of a discrete anomaly outlier or a drift anomaly outlier.

18. The non-transitory computer-readable medium of claim 16, the instructions further configured to cause:
identifying an anomaly event based on a statistical measure of a number of the input vectors within a designated timeframe corresponding to the anomaly value traversing the threshold.

19. The non-transitory computer-readable medium of claim 16, the instructions further configured to cause:
applying the threshold to one or more of: a number of input vectors determined to be abnormal, or a speed by which a statistical measure of the number of abnormal vectors changes within a designated timeframe.

20. The non-transitory computer-readable medium of claim 16, wherein the learning process includes one or more of: a continuous learning process or a periodic learning process.

21. The non-transitory computer-readable medium of claim 16, wherein the threshold is dynamically adjustable.

22. The non-transitory computer-readable medium of claim 16, wherein the knowledge map includes one or more of: a quality of the one or more knowledge elements, a model miss rate, a number of the one or more knowledge elements, a model hit count, one or more weights associated with the one or more knowledge elements, or an age of the one or more knowledge elements.

23. A computer-implemented method comprising:
obtaining, in association with a learning process, a plurality of input vectors;
iteratively processing the input vectors to compute a knowledge map;
iteratively processing the input vectors to determine metadata associated with one or more knowledge elements;
determining an anomaly value based on the knowledge map and the metadata; and
raising an alert that an anomaly was detected if the anomaly value traverses a threshold.

24. The method of claim 23, further comprising:
detecting at least one of a discrete anomaly outlier or a drift anomaly outlier.

25. The method of claim 23, further comprising:
identifying an anomaly event based on a statistical measure of a number of the input vectors within a designated timeframe corresponding to the anomaly value traversing the threshold.

26. The method of claim 23, further comprising:
applying the threshold to one or more of: a number of input vectors determined to be abnormal, or a speed by which a statistical measure of the number of abnormal vectors changes within a designated timeframe.

27. The method of claim 23, wherein the learning process includes one or more of: a continuous learning process or a periodic learning process.

28. The method of claim 23, wherein the threshold is dynamically adjustable.

29. The method of claim 23, wherein the knowledge map includes one or more of: a quality of the one or more knowledge elements, a model miss rate, a number of the one or more knowledge elements, a model hit count, one or more weights associated with the one or more knowledge elements, or an age of the one or more knowledge elements.
